(19) United States
(12) Patent Application Publication
(10) Pub. No.: US 2016/0378088 A1
(43) Pub. Date: Dec. 29, 2016

(54) REEL MANAGEMENT SYSTEM

(71) Applicant: Young-Jeon Son, Gyeonggi-do (KR)

(72) Inventor: Young-Jeon Son, Gyeonggi-do (KR)

(21) Appl. No.: 15/111,874

(22) PCT Filed: Apr. 21, 2014
(86) PCT No.: PCT/KR2014/003457

§ 371 Date: Sep. 14, 2016

(30) Foreign Application Priority Data
Jan. 15, 2014 (KR) 10-2014-0005189

(51) Int. Cl. G05B 19/12; G11B 9/00; G06K 7/10

(52) U.S. Cl. CPC G05B 19/124; G06K 7/10762; G06K 7/10297; G11B 9/00

(57) ABSTRACT

A reel management system is disclosed. A reel management system according to an embodiment of the present invention manages a reel in real time through registration, classification, and discharging, and automatically, accurately, and simply calculates the remaining amount of electronic components loaded on the reel.

### CROSS-REFERENCE TO RELATED APPLICATION

This application is an application for a national phase entry based on PCT International Application No. PCT/KR2014/003457, filed on Apr. 21, 2014 before the Korean Intellectual Property Office (KIPO), and claims priority under 35 USC §119 from, and the benefit of, Korean Patent Application No. 10-2014-0005189, filed on Jan. 15, 2014 in the Korean Intellectual Property Office (KIPO), the contents of which are herein incorporated by reference in their entirety.

### BACKGROUND

1. Technical Field

Embodiments of the present inventive concept are directed to the radio frequency identification (RFID) technology, and more specifically to the technology for recognizing information of objects based on the RFID technology.

2. Description of the Related Art

The RFID system is a non-contact recognition system for transmitting and processing the information of objects and their environment in a radio frequency (RF) by using small chips attached to the objects. The RFID system may include a reader having a data reading function, an RFID tag containing identification information, operating software, network, etc. The RFID system reads the relevant information from the RFID tag through identifying the RFID tag of a thin planar shape that is attached to an object. In the RFID identifying technology of the RFID system, the reader does not have to directly contact the RFID tag or scan within a visible band like a bar code. The RFID technology is evaluated as a technology capable of replacing the bar code because of such advantages, and its application range is very wide.

In the meantime, electronic components may be loaded on a reel. For example, the reel may be loaded with the electronic components in the manner that a tape loaded with the electronic components is wound around the reel. An RFID tag, from which information of the loaded electronic components on the reel can be known, may be attached to the reel. And, a reel storage rack may be used to store and manage the reels. By the way, if many reels are stored on the reel storage rack, users should check over all the reels one by one to find out the reel received with the wanted electronic components. It may cause waste of time and cost. Further, it may also hinder real-time management of remaining quantity of the electronic components. In order to determine the remaining quantity of the electronic components received in a tape reeled on a reel or the total remaining quantity of the electronic components kept in a warehouse, it is unavoidable for the user to check one by one with the naked eyes, which is inefficient and time-consuming.

### SUMMARY

Embodiments of the present inventive concepts provide a reel management system that can manage the reels in real-time, and automatically and simply calculate the remaining quantity of the electronic components loaded on the reel accurately.

According to exemplary embodiments of the present inventive concept, there is provided a reel management system. The reel management system includes a robot arm, including a first sensor for sensing a predetermined reel out of at least one reel loaded on a reel rest, for holding and moving the reel detected by the first sensor; an RFID reader for reading tag identification information to identify the reel using an RFID signal from an RFID tag attached to the reel moved by the robot arm; a barcode reader for reading barcode information assigned to the reel moved by the robot arm; a memory unit for storing reel-relevant information; and a control unit for driving the robot arm, determining a state of the reel, and when the reel is identified with a new reel, associating the tag identification information of the reel read by the RFID reader with the barcode information read by the barcode reader, and storing the associated information in a database through the memory unit to register the reel.

According to other exemplary embodiments of the present inventive concept, there is provided other reel management system. The reel management system includes a robot arm, including a first sensor for sensing a predetermined reel out of at least one reel loaded on a reel rest, for holding and moving the reel detected by the first sensor; a second sensor for detecting a diameter size of a tape wound on a reel held by the robot arm or wound on each of the entire reels loaded on the reel rest prior to being held by the robot arm; a control unit for driving the robot arm, and calculating remaining quantity of components received in a desired reel based on the diameter size of the tape wound on the desired reel; an RFID reader for reading tag identification information to identify the reel using an RFID signal from an RFID tag attached to the reel moved by the robot arm; and a memory unit for storing identification information of the reel read through the RFID reader and remaining quantity of the components loaded on the desired reel calculated by the control unit, in a form of associated information.

Embodiments of the present inventive concept can allow a user to register information of a desired reel, and manage and use the registered reel information in real time. In particular, it is possible to register in real time information of a reel that is regarded as a new one, and manage it based on the determination as to whether the reel is normal or not.

According to other embodiments of the present inventive concept, it is possible to automatically measure a remaining quantity of the components loaded on the reel. There is no need for the user to check over the remaining quantity of the components loaded on the reel one by one with the naked eyes. Furthermore, as the remaining quantity of the components received in the reel can be measured correctly and quickly using the robot, operability and productivity can be raised. It is also possible to read the information of remaining quantity of the components based on the RFID technology using the RFID tag and the RFID reader.

### BRIEF DESCRIPTION OF THE DRAWINGS

FIG. 1 is an external view of a reel to be managed according to an embodiment of the present inventive concept.

FIGS. 2a and 2b are external side views of reel rests according to embodiments of the present inventive concept.

FIGS. 3a and 3b are external views of the reel rests having a reel support according to embodiments of the present inventive concept.

FIGS. 4a to 4d are external views of reel management systems according to several embodiments of the present inventive concept.

FIGS. 5a and 5b are external views of robot arms according to embodiments of the present inventive concept.

FIGS. 6a to 6d are block diagrams of reel management systems according to several embodiments of the present inventive concept.

FIG. 7 is an external view of a storage unit according to an embodiment of the present inventive concept.

FIGS. 8a to 8e illustrate an operation process of a reel management system according to a second embodiment of the present inventive concept.

FIGS. 9a to 9e illustrate an operation process of a reel management system according to a third embodiment of the present inventive concept.

FIGS. 10a to 10d illustrate an operation process of a reel management system according to a fourth embodiment of the present inventive concept.

### DETAILED DESCRIPTION OF THE EMBODIMENTS

Hereinafter, several exemplary embodiments of the present disclosure will be described more fully with reference to the accompanying drawings. In the description of the present disclosure, when it is believed that detailed descriptions of any known function or element may unnecessarily cause the present inventive concept to be unclear, the descriptions may not be provided. In addition, the terms used hereafter are those defined in consideration of the functions in the present disclosure and they may vary according to intentions of users or operators, custom, etc. Therefore, their definitions should be made based on the disclosure throughout the present specification.

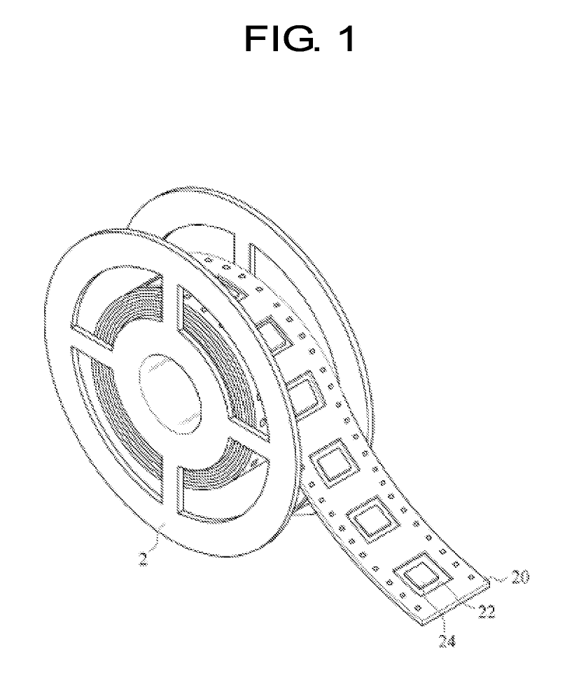

In FIG. 1, illustrated is an external view of the reel 2 to be managed according to an exemplary embodiment of the present disclosure.

Referring to FIG. 1, a tape 20 is reeled on a reel 2, and the tape 20 is formed with a plurality of receiving spaces 22 in which electronic components 24 are placed. That is, the tape 20 received with the electronic components (hereinafter shortly ‘components’) 24 is wound on the reel 2. The component 24 may be, for example, a semiconductor chip. According to the present disclosure, the works such as registration, classification, discharge, measurement of remaining quantity of the reels 2 and the components 24 received in each of the reels 2 can be precisely performed in real time.

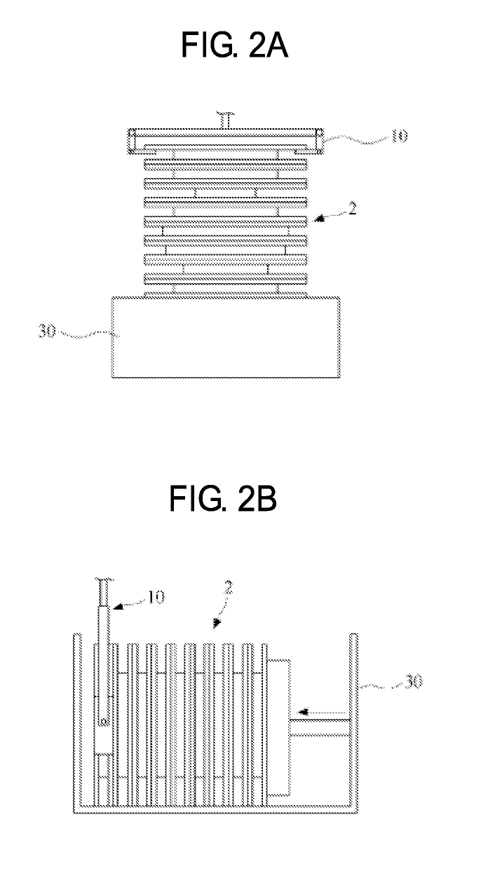

FIGS. 2a and 2b illustrate external views of a reel rest 30 in accordance with exemplary embodiments of the present disclosure.

The reel rest 30 is a structure on which a number of reels 2 are placed. The reel rest 30 may have several types of structure as shown in FIGS. 2a and 2b. The reel rest 30 shown in FIG. 2a is a type of stacking the reels 2 in a vertical direction, that is, upwardly one on top of the other in turn. In this type of the reel rest 30, the reel at the top can be lifted upwardly with a robot arm 10. The reel rest 30 shown in FIG. 2b is a type of placing the reels 2 to be arranged in a line in a horizontal direction on the reel rest 30. In this type of the reel rest 30, the leftmost or rightmost reel can be lifted upwardly by the robot arm 10. The reel rest 30 may be a structure that for example when the leftmost reel is lifted up, the rightmost reel is pushed leftward by a push bar so that all the reels 2 can be pushed leftward so as not to leave any blank space in the leftmost region of the reel rest 30.

FIGS. 2a and 2b illustrate the reels 2 having the same size, but size of the reels 2 may be different from each other. For example, their outer diameters may be different from each other, or their inner diameters may be different from each other. In addition, the structures of the reel rest 30 described above with reference to FIGS. 2a and 2b are just exemplary embodiments to help understanding of the present inventive concept, and thus the reel rest 30 may be modified to any other structure.

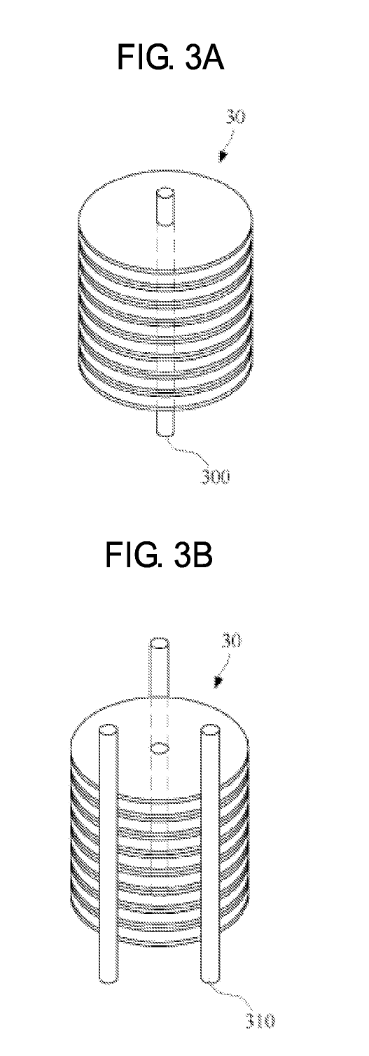

In FIGS. 3a and 3b, illustrated are external views of the reel rest 30 having a reel support 300 or 310 in accordance with exemplary embodiments of the present disclosure.

Referring to FIGS. 3a and 3b, the reel rest 30 includes one or more reel supports 300 or 310 so as to keep the reels in a line. The reel support(s) 300 or 310 fixes and supports the reels loaded on the reel rest 30 not to move. In particular, the reels loaded on the reel rest 30 are supported by the reel support(s) 300 or 310 to be arranged in a line along their loading direction.

With reference to FIG. 3a, the reel support 300 may be a rod structure to be inserted into a hole formed at the center of each reel 2. Referring to FIG. 3b, the reel support 310 may be a tripod-like structure that supports lateral sides of the reels 2 not so as to move. The reel support 310 may be a structure that can adjust its supporting position relying on size of the reels. The user can widen a receiving diameter of the supporting-position adjustable type reel supports 310 when the size of the reel 2 is large, and reduce the receiving diameter when the size of the reel 2 is small. By adjusting the supporting position of the reel supports 310 to be suited for the size of the reel 2, the reel supports 310 can support the reels 2 regardless of their sizes. The structures of the reel supports 300 or 310 described above with reference to FIGS. 3a and 3b are just exemplary to help understanding of the present inventive concept, and thus the reel supports 300 or 310 may be modified to any other forms.

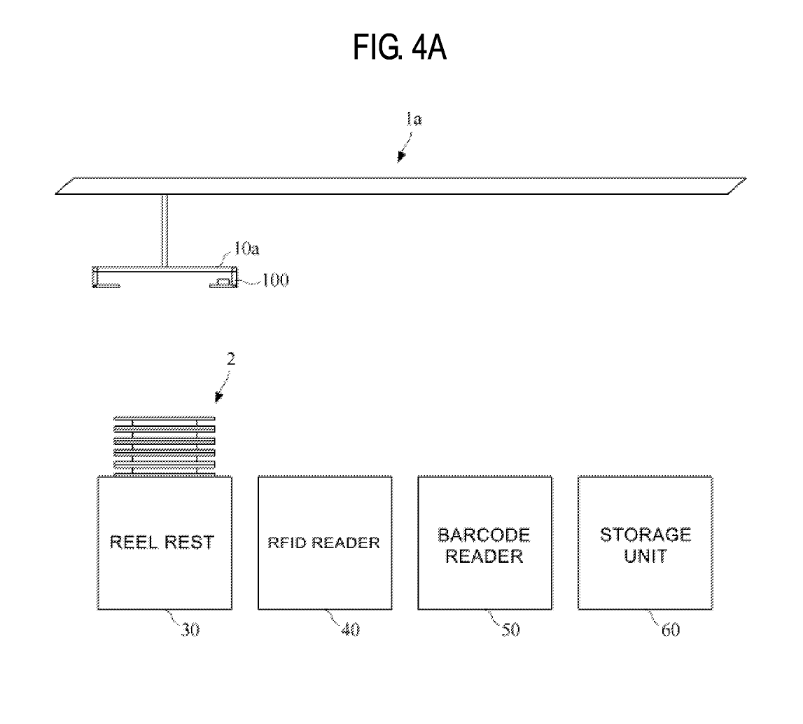

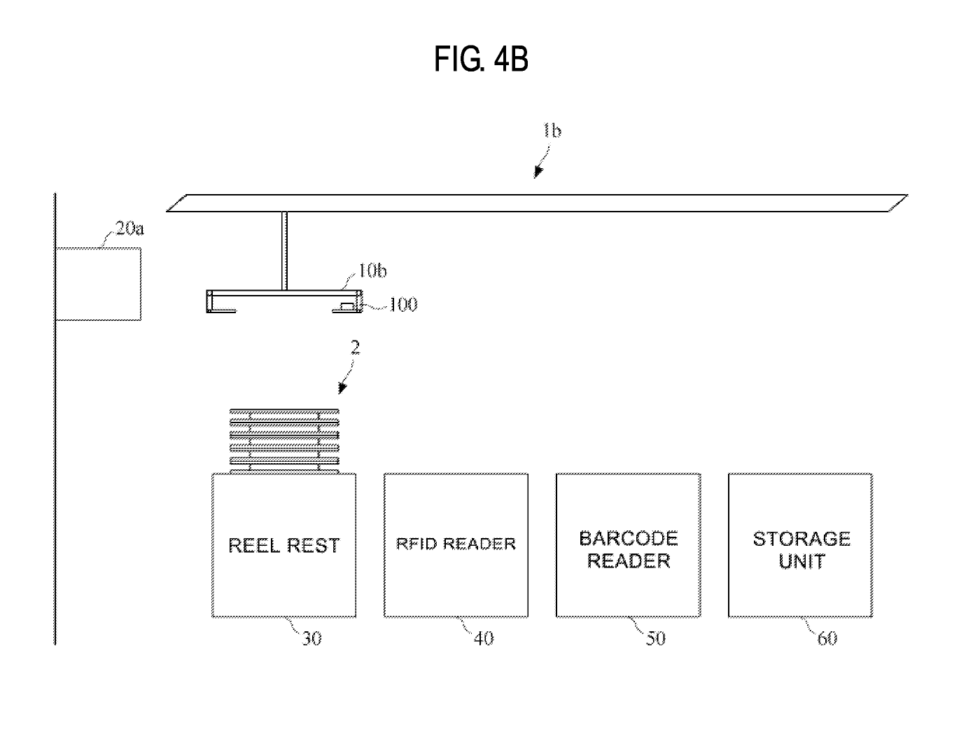

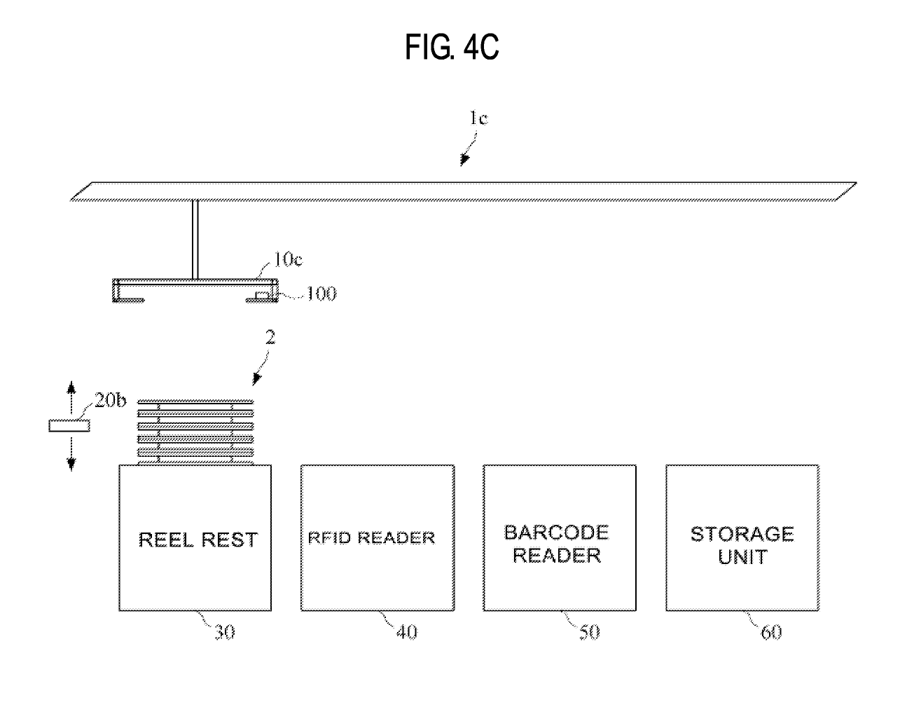

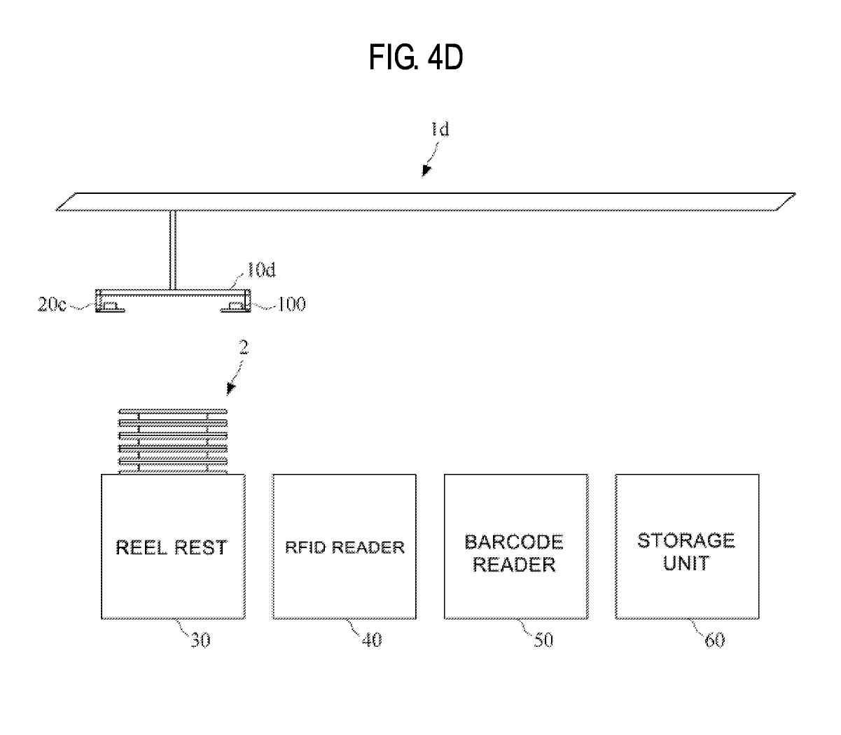

FIGS. 4a to 4d show configurations of reel management systems 1a, 1b, 1c, and 1d according to several exemplary embodiments of the present disclosure.

In FIG. 4a, the reel management system 1a according to the first embodiment of the present disclosure is illustrated.

Referring to FIG. 4a, the reel management system 1a according to the first embodiment is to register, manage and operate information of the reels 2 and the components received in the reels 2. The reel management system 1a may include a robot arm 10a having a first sensor 100, an RFID reader 40 and a barcode reader 50. The reel management system 1a may further include a storage unit 60.

The robot arm 10a automatically performs a series of operations according to a preset work schedule. The works to be done by the robot arm 10a may include an operation of lifting-up a desired reel out of the reels 2 loaded on the reel rest 30, an operation of moving the lifted reel to the vicinity of the RFID reader 40 and/or a barcode reader 50, an operation of moving the reel to the storage unit 60 for storage, etc. The robot arm 10a may be a pendant type that it is movably hanging from the ceiling as shown in FIG. 4a, but is not limited to that.

The robot arm 10a according to the first embodiment may include a first sensor 100. The first sensor 100 detects a desired reel among the reels 2 loaded on the reel rest 30, and the robot arm 10a lifts up the reel detected by the first sensor 100. If the reels 2 are upwardly stacked on the reel rest 30, the reel detected by the first sensor 100 and lifted up by the robot arm 10a may be the reel at the highest position among the reels loaded on the reel rest 30. If the reels 2 are arranged in a line in the horizontal direction on the reel rest 30, the reel detected by the first sensor 100 and lifted up by the robot arm 10a may be the reel at the leftmost or rightmost position among the reels on the reel rest 30.

The robot arm 10a can lift up directly a desired reel from the reel rest 30, and alternatively the reel 2 on the reel rest 30 may be raised up to the position of the robot arm 10a without being lifted up directly as such. The reel raised up to the position of the robot arm 10a can be detected by the first sensor 100 and held by the robot arm 10a. In that case, a mechanical method may be used to raise all or some of the reels 2 loaded on the reel rest 30 up to the position of the robot arm 10a.

On the other hand, the number of the reel that can be held by the robot arm 10a at a time may be one or multiple. If the robot arm 10a can hold a plurality of the reels 2, the RFID reader 40 should be provided as many as the number of the reels 2 that the robot arm 10a holds at a time. In this case, the robot arm 10a distributes reels to the RFID readers 40 one to one so that each of the RFID readers 40 can recognize the reel distributed to itself.

The RFID reader 40 communicates an RFID signal with an RFID tag attached to the reel 2 via RFID antennas. The RFID reader 40 can read tag identification information from the RFID tag of the reel 2 lifted up by the robot arm 10a and identify the corresponding reel, or record the tag identification information to the RFID tag.

The RFID tag can be recorded with the identification information and production history data of the components received in the reel. The identification information is associated with the components received in the reel and may include a component code, a manufacturer name, a production year, a production lot number, etc. Manufacturing history data indicates a history from loading the components on the reel to using the components for the production, that is, a history capable of specifying the date of using the components and a work line and/or an apparatus for mounting the components. In addition, the RFID tag may be recorded with the remaining quantity of the components received in a relevant reel. The number of the remaining components represents the number of the remaining components accommodated by the tape wound on the reel.

The RFID reader 40 may be formed at a separate location apart from the robot arm 10a as shown in FIG. 4a. According to an example, the robot arm 10a transfers the lifted reel to the vicinity of the RFID reader 40 and recognizes the identification information of the reel via the RFID reader 40. In another example, the RFID reader 40 may be mounted or embedded in the robot arm 10a. In this case, the robot arm 10a can read identification information of the lifted reel through the RFID reader 40 installed in the robot arm 10a.

The bar code reader 50 reads a barcode attached to the lifted reel via the robot arm 10a. When the RFID reader 40 succeeds in reading the identification information of the RFID tag but the read identification information of the RFID tag has not been registered yet in a database, the barcode information can be read by the barcode reader 50. In the storage unit 60, the reels having passed through the RFID reader 40 and the barcode reader 50 are kept.

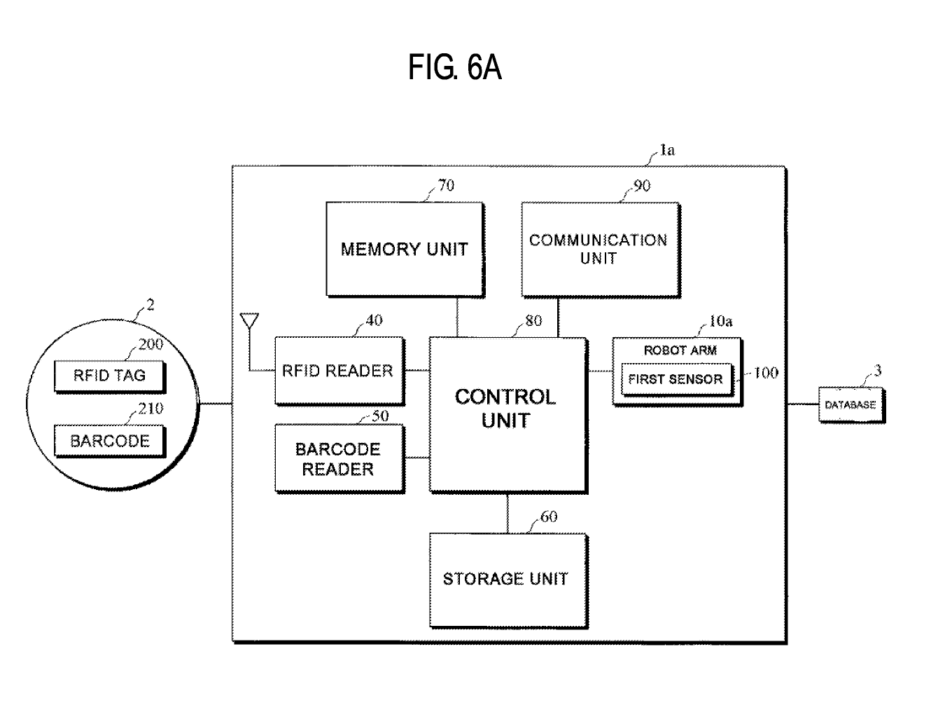

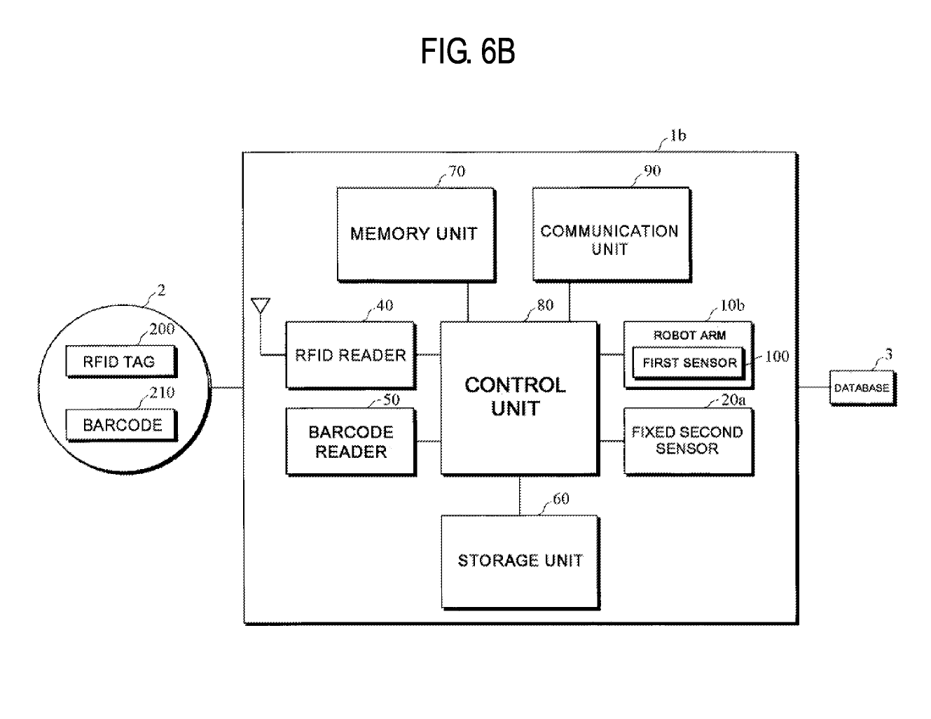

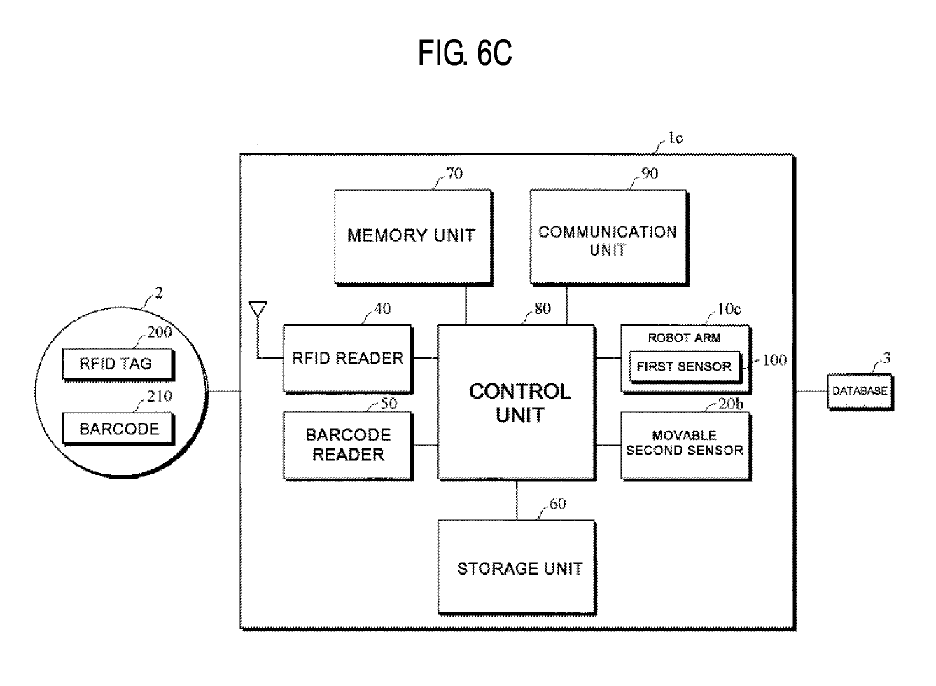

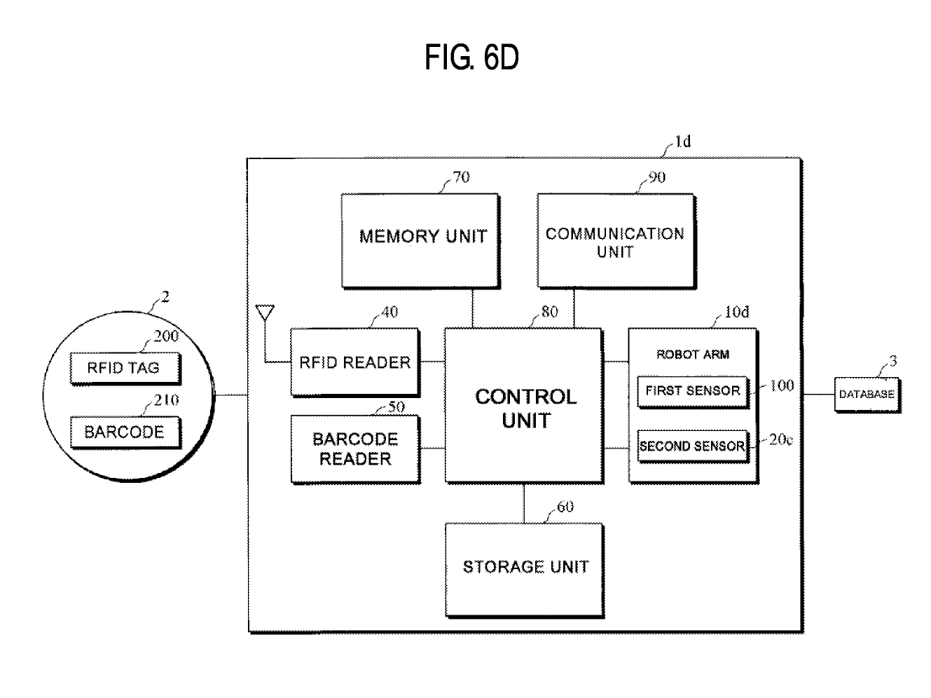

Referring to FIG. 4a, in accordance with an embodiment the barcode reader 50 may be located just next to the RFID reader 40. In this case, the reel is lifted up and transferred to the barcode reader 50 by the robot arm 10a through the RFID reader 40. According to another embodiment, the barcode reader 50 may be located just before the RFID reader 40. In this case, the barcode reader 50 operated by the user reads the barcode of a reel prior to lifting the reel by means of the robot arm 10a, and then the reel is lifted up and transferred to the position of the RFID reader 40 by the robot arm 10a. This can be applied to the case that the reel is a new one. The configuration of the reel management system 1a of which schematic appearance has been described as above with reference to FIG. 4a will be further described in detail with reference to FIG. 6a.

With reference to FIGS. 4b to 4d, configuration of other reel management systems 1b, 1c, and 1d will be schematically described according to other exemplary embodiments. One of the main differences between the reel management system 1a described with reference to FIG. 4a and the reel management systems 1b, 1c, and 1d to be described with reference to FIGS. 4b to 4d is as follows. The reel management systems 1b, 1c, and 1d shown in FIGS. 4b to 4d are focused on measurement of remaining quantity of the components received in a reel, whereas the reel management system 1a shown in FIG. 4a is focused on not the measurement of the remaining quantity of the components but registration, management and operation of the information of the reels regardless of the measurement of the remaining quantity of the components.

In detail, FIG. 4b illustrates a schematic external view of the reel management system 1b according to the second embodiment of the present disclosure.

With reference to FIG. 4b, the reel management system 1b according to the second embodiment may include a robot arm 10b having the first sensor 100, a fixed type second sensor 20a separated from the robot arm 10b, and the RFID reader 40. The reel management system 1b may further include the barcode reader 50 and the storage unit 60.

The robot arm 10b automatically performs a series of operations according to a work schedule. The works to be performed by the robot arm 10b may include an operation to lift up any one reel out of the reels 2 loaded on the reel rest 30, an operation to move the lifted reel to the vicinity of the RFID reader 40 and a barcode reader 50, an operation to move the reel to the storage unit 60 for storage, etc. The robot arm 10b may be a pendant type that it is movably hanging from the ceiling as shown in FIG. 4b, but is not limited to that.

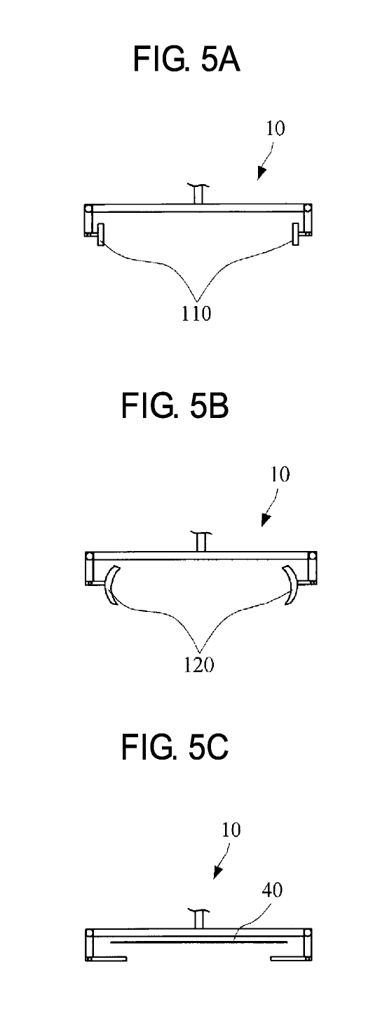

The robot arm 10b has a gripper to grip, lift up, and move the reel 2. The robot arm 10b may include two grippers for gripping the reel at two opposite positions and lifting it up. Several embodiments of the gripper will be described later with reference to FIGS. 5a and 5b. If the reel rest 30, the RFID reader 40, the barcode reader 50, and the storage unit 60 are positioned in a working space on a guide rail, the robot arm 10b may be a movable type capable of moving along the guide rail.

The robot arm 10b according to the second embodiment may include the first sensor 100. The first sensor 100 detects a desired reel among the reels 2 loaded on the reel rest 30, and the robot arm 10b lifts up the reel detected by the first sensor 100. If the reels 2 are upwardly stacked on the reel rest 30, the reel detected by the first sensor 100 and lifted up by the robot arm 10b may be the reel at the highest position among the reels loaded on the reel rest 30. If the reels 2 are arranged in a line in the horizontal direction on the reel rest 30, the reel detected by the first sensor 100 and lifted up by the robot arm 10b may be the reel at the leftmost or rightmost position among the reels on the reel rest 30.

The second sensor 20a according to the second embodiment may be fixed to a position, separated from the robot arm 10b, of a predetermined height as shown in FIG. 4b. Here, it is preferable to install the second sensor 20a at a position around which there is no obstacle so that the robot arm 10b cannot be bumped against any workpiece, in particular, the reels loaded on the reel rest 30 in a workspace, and the second sensor 20a can recognize the reel lifted up by the robot arm 10b. The installation position of the second sensor 20a may be adjusted according to the work environment.

The robot arm 10b can lift up directly a desired reel from the reel rest 30, but if the reel 2 along with the reel rest 30 may be raised up to the position of the robot arm 10b without being lifted up directly as such, the robot arm 10b can detect the reel raised up to itself through the first sensor 100 and hold it. In that case, a mechanical method may be used to raise all or some of the reels 2 loaded on the reel rest 30 up to the position of the robot arm 10b.

The second sensor 20a detects a diameter size of the tape wound on a reel lifted up to the level of the second sensor 20a by the robot arm 10b. The information of the diameter size detected by the second sensor 20a is used for calculating remaining quantity of the components received in a tape reeled on the reel.

The second sensor 20a may be an optical displacement sensor that irradiates an optical signal to a reel having been moved to the height of the second sensor 20a and calculates a diameter size of the tape reeled on the reel based on a reflected signal. As another example, the second sensor 20a may be an image sensor that acquires an image from a reel having been moved to the height of the second sensor 20a and calculates a diameter size of the tape reeled on the reel using the acquired image.

The RFID reader 40 communicates an RFID signal with the RFID tag attached to the reel 2 via the RF antennas. The RFID reader 40 can read tag identification information from the RFID tag of the reel 2 lifted by the robot arm 10b and identify the reel, or record the tag identification information to the RFID tag.

The RFID reader 40 may be formed at a separate location apart from the robot arm 10b as shown in FIG. 4b. According to an example, the robot arm 10b transfers the lifted reel to the vicinity of the RFID reader 40 and recognizes the reel via the identification information read by the RFID reader 40. In another example, the RFID reader 40 may be mounted on or embedded in the robot arm 10b. In this case, the robot arm 10b can recognize the lifted reel based on the identification information of the reel read by the RFID reader 40 installed in the robot arm 10b.

The bar code reader 50 reads the barcode attached to the reel lifted by the robot arm 10a. In a case that the RFID reader 40 succeeds in reading the identification information of the RFID tag but the database is not registered with the read identification information of the RFID tag, the barcode information can be read by the barcode reader 50.

In the storage unit 60, the reels having passed through the RFID reader 40 and the barcode reader 50 are kept.

FIG. 4c illustrates a schematic external view of the reel management system 1c according to the third embodiment of the present disclosure.

With reference to FIG. 4c, the reel management system 1c according to the third embodiment may include a robot arm 10c having the first sensor 100, a second sensor 20b being movable and separated from the robot arm 10c, and the RFID reader 40. The reel management system 1c may further include the barcode reader 50 and the storage unit 60.

The reel management system 1b shown in FIG. 4b according to the second embodiment measures the remaining quantity of the components received in one reel. In contrast, the reel management system 1c shown in FIG. 4c according to the third embodiment is focused on measuring the remaining quantity of the components received in all the reels loaded on the reel rest 30.

In detail, the second sensor 20b according to the third embodiment, being a type separated from the robot arm 10c, scans over all the reels loaded on the reel rest 30 and detects a diameter size of each tape reeled on each of all the reels while traveling over all the reels.

The first sensor 100 according to the third embodiment may be built in the robot arm 10c and detects any one reel out of all the reels of which diameter sizes of the tapes have been detected by the second sensor 20b. The robot arm 10c lifts up the one reel detected by the first sensor 100. For example, if the reels 2 are upwardly stacked on the reel rest 30, the reel detected by the first sensor 100 and lifted up by the robot arm 10c may be the reel at the highest position among the reels loaded on the reel rest 30. In contrast, if the reels 2 are arranged in a line in the horizontal direction on the reel rest 30, the reel detected by the first sensor 100 and lifted up by the robot arm 10c may be the reel at the leftmost or rightmost position among the reels on the reel rest 30.

The RFID reader 40 transmits and receives an RFID signal to/from an RFID tag attached to the reel through the RFID antennas. The RFID reader 40 reads tag identification information from the RFID tag of the reel 2 lifted by the robot arm 10c and identifies the corresponding reel, or records the tag identification information to the RFID tag. The bar code reader 50 reads the barcode attached to the lifted reel by the robot arm 10c. In a case that the RFID reader 40 succeeds in reading the identification information of the RFID tag but the database is not registered with the read identification information of the RFID tag, the barcode reader 50 may read the barcode information. In the storage unit 60, the reels having passed through the RFID reader 40 and the barcode reader 50 are kept.

FIG. 4d illustrates a schematic external view of the reel management system 1d according to the fourth embodiment of the present disclosure.

With reference to FIG. 4d, the reel management system 1d according to the fourth embodiment may include a robot arm 10d having the first sensor 100 and the second sensor 20c, and the RFID reader 40. The reel management system 1d may further include the barcode reader 50 and the storage unit 60.

In the robot arms 10b and 10c described above with reference to FIGS. 4b and 4c, the second sensors 20a and 20b are installed at a position apart from the robot arms 10b and 10c. In contrast, in the robot arm 10d according to the fourth embodiment shown in FIG. 4d, the second sensor 20c is mounted on or built in the robot arm 10d. In the robot arm 10d including the first sensor 100 and the second sensor 20c, the first sensor 100 detects one reel out of the reels loaded on the reel rest 30, and the robot arm lifts up the detected reel. The second sensor 20c detects a diameter size of the tape reeled on the lifted reel during the lifting operation of the reel.

In detail, the first sensor 100 installed in the robot arm 10d detects one reel out of all the reels loaded on the reel rest 30. Then, the second sensor 20a installed in the robot arm 10d measures the diameter size of the tape wound on the reel detected by the first sensor 100. For this, the second sensor 20c detects contact of the robot arm 10d to the tape wound on the reel which has been detected by the first sensor 100 and obtains the information of diameter size of the contacted tape.

The RFID reader 40 transmits and receives an RFID signal to/from an RFID tag attached to the reel by using the RFID antennas. The RFID reader 40 reads tag identification information from the RFID tag of the reel 2 lifted by the robot arm 10d and identifies the corresponding reel, or records the tag identification information to the RFID tag. The barcode reader 50 reads the barcode attached to the reel lifted by the robot arm 10d. In a case that the RFID reader 40 succeeds in reading the identification information of the RFID tag but the database is not registered with the same tag identification information as the identification information read from the RFID tag, the barcode information can be read by the barcode reader 50. In the storage unit 60, the reels having passed through the RFID reader 40 and the barcode reader 50 are kept.

FIGS. 5a and 5b illustrate schematic external views of the robot arm 10 in accordance with exemplary embodiments of the present disclosure.

In FIG. 5a, the gripper 110 of the robot arm 10 may be a linear type. With reference to FIG. 5b, the gripper 120 of the robot arm 10 may be a curved type so as to easily grip and lift the circular reel. FIG. 5c shows an example of the robot arm 10 containing the RFID reader 40. If the RFID reader 40 is separated from the robot arm 10, it is required that the robot arm 10 should move the reel to the vicinity of the RFID reader 40. However, if the RFID reader 40 is mounted on or built in the robot arm 10 as shown in FIG. 5c, the robot arm 10 can identify the reel based on its identification information while the robot arm 10 lifts up and moves the reel.

Next, several types of the reel management systems 1a, 1b, 1c, and 1d including an internal processor will be described with reference to FIGS. 6a to 6d.

FIG. 6a is a block diagram of the reel management system 1a according to a first embodiment of the present disclosure.

Referring to FIG. 6a, the reel management system 1a according to the first embodiment includes the robot arm 10a having the first sensor 100, the RFID reader 40, the barcode reader 50, the storage unit 60, a memory unit 70, a control unit 80, and a communication unit (90). The configuration of the reel management system 1a according to the first embodiment is the same as that described above in FIG. 4a.

The robot arm 10a includes a first sensor 100 for detecting a desired reel out of the reels loaded on the reel rest 25, and holds and moves the detected reel to the positions of the RFID reader 40, the barcode reader 50 and the storage unit 60. Description of the first sensor 100 will be omitted as previously described in detail with reference to FIG. 6b.

The RFID reader 40 reads the tag identification information via an RFID signal from the RFID tag 200 attached to the reel having been moved by the robot arm 10a to identify the reel, or records tag identification information to the RFID tag 200. The barcode reader 50 reads the barcode 210 attached to the reel having been moved by the robot arm 10a. Here, the barcode reader 50 may read the barcode information from the barcode 210 in a case that reading the tag identification information from the RFID tag by the RFID reader 40 succeeded but the read tag identification information has not been registered in the database 3.

The memory unit 70 stores the tag identification information, the barcode information, any basic information of the reel, etc. The memory unit 70 may store these kinds of information in the database 3. The database 3 may be located in the reel management system 1a. Alternatively, the database 3, being separated from the reel management system 1a, may be located in a separate server apart from the reel management system 1a.

The control unit 80 generally manages other elements of the reel management system. In detail, the control unit 80 drives the robot arm 10a, and determines a status of the reels. According to an exemplary embodiment, the control unit 80 determines whether the reel is a new one or not based on the determination of its status. If the reel is deemed a new reel, the control unit 80 associates the tag identification information of the reel read through the RFID reader 40 with the barcode information read through the barcode reader 50, and stores the associated information in the database through the memory unit 70 to register the corresponding reel. At that time, the control unit 80 searches for the same identification information as the identification information read by the RFID reader 40 from the database 3, and if the identification information is not searched from the database 3, the reel can be deemed the new one.

The control unit 80 according to an exemplary embodiment retrieves the basic information corresponding to the barcode information read by the barcode reader 50 from the database 3, and fetches the searched basic information from the database 3. The basic information may include, for example, a component code, a manufacturer name, a production year, a production lot number, etc. In addition, the basic information may further include a history from loading the components on the reel to using the components for product production, that is, production history data capable of specifying the use date of the components for the product production, component mounting operation line/apparatus, etc.

Then, the control unit 80 associates the basic information retrieved from the database 3 with the tag identification information read through the RFID reader 40, then further associating the tag identification information associated with the basic information with the barcode information read through the barcode reader 50, and storing the associated information in the database 3. After the basic information is associated with the tag identification information, the control unit 80 can read the tag identification information as well as the basic information when it reads the tag identification information from the RFID reader 40.

According to an exemplary embodiment, the control unit 80 determines whether the reel is normal or not according to the recognition result by at least one of the RFID reader 40 and the barcode reader 50. That is, the reel is deemed a normal one in the following cases: a case that the RFID reader 40 succeeds in reading the identification information of the RFID tag and the same identification information as the identification information of the RFID tag read by the RFID reader 40 exists in the database 3, and another case that the RFID reader 40 succeeds in reading the identification information of the RFID tag and the same identification information as the identification information of the RFID tag read by the RFID reader 40 does not exist in the database 3, but the barcode reader 50 succeeds in reading the barcode information.

In contrast, the reel is deemed an abnormal one in the following cases: a case that it fails for the RFID reader 40 to read the identification information of the RFID tag, or another case that the RFID reader 40 succeeds in reading the identification information of the RFID tag but the database 3 is not registered with the read tag identification information, and thus it is tried for the barcode reader 50 to read the barcode information but failed to read the barcode information.

The communication unit 90 transmits component information, tag identification information, barcode information, etc. to the database 3 through a network, and the transmitted information is stored in the database 3. In addition to the transmission of the information to the database 3, the communication unit 90 may receive the component information from the database 3 through the network. The component information may include identification information and production history data of the components received in the reel. The identification information relates to the received components in the reel, and may include a component code, a manufacturer name, a production year, a production lot number, etc. The production history data indicates a history from loading the components on the reel to using them for production. Further, the component information may include the remaining quantity of the components received in the reel.

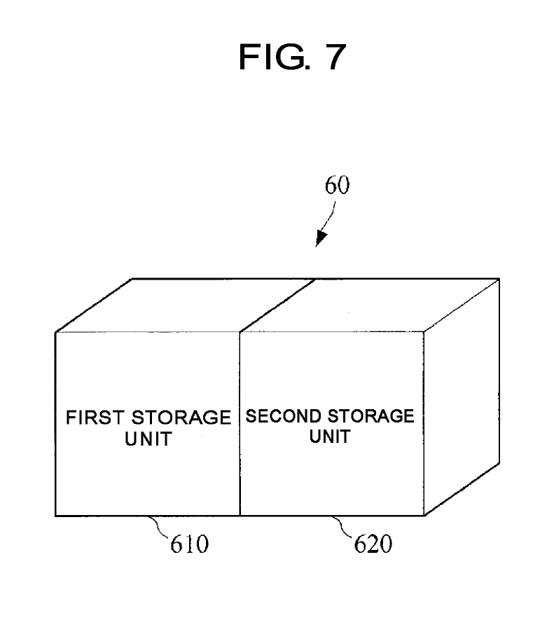

The storage unit 60 stores the reels having passed through the RFID reader 40 and the barcode reader 50. It may be possible to distinguishably store the normal reel and the abnormal reel in different spaces according to whether the reel is deemed normal or abnormal by means of the RFID reader 40 and the barcode reader 50. Detailed embodiment of the storage unit 60 will be described later with reference to FIG. 7.

FIG. 6b illustrates a block diagram of the reel management system 1b according to the second embodiment of the present disclosure.

With reference to FIG. 6b, the reel management system 1b according to the second exemplary embodiment may include the robot arm 10c having the first sensor 100, the fixed type second sensor 20a separated from the robot arm 10c, the RFID reader 40, the barcode reader 50, the storage unit 60, a memory unit 70, a control unit 80, and a communication unit 90. The external view of the reel management system 1b according to the second embodiment is the same as that described in FIG. 4b above.

The robot arm 10c may include the first sensor 100 for detecting one reel out of the reels loaded on the reel rest 30, and lift up the reel detected by the first sensor 100. If the reels are stacked upwardly, that is, in the vertical direction on the reel rest 30, the reel detected by the first sensor 100 and lifted up by the robot arm 10c may be the one at the highest position among the reels 2 on the reel rest 30. If the reels are arranged in the horizontal direction on the reel rest 30, the reel detected by the first sensor 100 and lifted up by the robot arm 10c may be the reel at the leftmost or rightmost position among the reels 2.

The first sensor 100 in accordance with one exemplary embodiment may be an optical sensor that detects the edge of the reel through transmitting and receiving an optical signal to/from the reels loaded on the reel rest 30. The reels 2 loaded on the reel rest 30 are arranged in a line. When the edge of a reel is firstly detected by the first sensor 100, the control unit 80 controls the robot arm 10c to pause and move the robot arm 10c to the detected reel. Then, the control unit 80 controls the robot arm 10c to lift up the reel with a gripper of the robot arm 10c.

Hereinafter, an exemplary operation that the robot arm 10c detects a reel 2 from the reel rest 30 using the first sensor 100 and lifts it up will be described.

In accordance with an exemplary embodiment, the first sensor 100 may be an optical sensor. The robot arm 10c which is driven by the control unit 80 begins its operation in a state that the spacing between the two grippers is wider than a predetermined size of the reel 2. That is, the robot arm 10c of which two gripper's spacing is wider than the reel size moves toward the reel rest 30. For example, if the reels 2 are stacked in the vertical direction on the reel rest 30, the robot arm 10c mounted on the ceiling detects the edge of the reel via the first sensor 100 while moving downwardly. At that time, when detecting the edge of a reel firstly, the robot arm 10c pauses. Then, the robot arm 10c moves over the detected reel and lifts it up with the two grippers.

According to another exemplary embodiment, the first sensor 100 may include a first optical sensor and a second optical sensor. The robot arm 10c driven by the control unit 80 detects the reel by the first optical sensor while moving toward the reel rest 30. For example, if the reels 2 are stacked in the vertical direction on the reel rest 30, the robot arm 10c located in the ceiling detects the reel 2 through the first optical sensor while it gradually moves downwardly. The robot arm 10c can move in a constant speed with its two grippers spaced apart from each other. When a reel is detected by the first optical sensor, the robot arm 10c spreads out the two grippers wider than a size of the detected reel and then moves toward the reel rest 30. Then, when the second optical sensor firstly detects the edge of the detected reel, the robot arm 10c stops temporarily. Then, the robot arm 10 moves over the detected reel and lifts it up with the two grippers.

The second sensor 20a detects a diameter size of the tape wound on the reel lifted up by the robot arm 10c. In accordance with an exemplary embodiment, the second sensor 20a is separated from the robot arm 10c and fixed to a position of a predetermined height. The second sensor 20a detects the diameter size of the tape wound on the reel lifted up to the height of the second sensor 20a by the robot arm 10c. Hereinafter, several types of the second sensor 20a that are separated from the robot arm 10c and fixed to a position of a predetermined height will be described.

The second sensor 20a according to an exemplary embodiment, being separated from the robot arm 10c and fixed to a position of a predetermined height, may be an optical displacement sensor that irradiates an optical signal to a reel lifted up to the height of the second sensor 20a and detects a diameter size of the tape reeled on the reel from the reflected optical signal. The second sensor 20a according to another exemplary embodiment, being separated from the robot arm 10c and fixed to a position of a predetermined height, may be an image sensor that acquires an image from the reel lifted up to the second sensor 20a and obtains the diameter size of the tape reeled on the reel from the image.

In the meantime, the control unit 80 can drive the robot arm 10c and calculate a remaining quantity of the components received in the reel based on the diameter size of the tape detected by the second sensor 20a. For example, the number of the remaining components can be calculated based on the pre-known information such as a diameter of a tape roll, a diameter of the blank space in the tape roll, number of the total components, etc. and the detected information such as the diameter size of the remaining tape roll detected by the second sensor 20a. The above-described method for calculating the remaining quantity of the components is just an example and there may be any other several methods for the calculating.

The RFID reader 40 identifies the reel lifted up by the robot arm 10c by reading the tag identification information via an RFID signal from the RFID tag 200 attached to the lifted reel, or records the tag identification information in the RFID tag 200. With the tag identification information of the RFID tag 200 of the reel read by the RFID reader 40, the control unit 80 checks whether there is the same information as the read tag identification information in the database 3 or not. When it is determined that the database 3 has the same information as the read tag identification, the number of the remaining components calculated by the control unit 80 is recorded in the database 3 that has the tag identification information so as to be added to the information of the reel.

According to an exemplary embodiment, the RFID reader 40 may be located apart from the robot arm 10c, and the robot arm 10c driven by the control unit 80 moves the lifted reel to the vicinity of the RFID reader 40. The RFID reader 40 reads the identification information from the RFID tag 200 to identify it. According to another exemplary embodiment, the RFID reader 40 may be mounted on or built in the robot arm 10c. In that case, the RFID reader 40 reads the identification information of the reel lifted up by the robot arm 10c for its identification.

The memory unit 70 stores the identification information of the reel read by the RFID reader 40 with the number of the remaining components of the reel calculated by the control unit 80 in a form of associated information in the database 3. Here, the database 3 may be located in the reel management system 1b. Alternatively, the database 3 may be located in a server separated from the reel management system 1b. Further, the memory unit 70 may directly record the number of the remaining components calculated by the control unit 80 in the RFID tag 200 of the corresponding reel.

The communication unit 90 transmits the component information, the tag identification information, the barcode information, etc. to the database 3 via the network, and the transmitted information is stored in the database 3. In addition to the transmission of such information, the communication unit 90 may receive the component information from the database 3 via the network. The component information may include the identification information and production history data of the components received in the reel. The identification information relates to the components received in the corresponding reel, and may include a component code, a manufacturer name, a production year, a production lot number, etc. The production history data indicates a component-relevant history from loading the components on the reel to using them for the product production. Further, the component information may include information of the remaining quantity of the components received in the reel.

The bar code reader 50 reads the barcode 210 attached to the reel lifted by the robot arm 10c to identify the reel. The memory unit 70 may store the barcode information read by the barcode reader 50 with the tag identification information of the reel in a form of associated information.

According to an exemplary embodiment, the barcode reader 50 may be located next to the RFID reader 40. In this arrangement, the identification information of the RFID tag 200 of the reel is read through the RFID reader 40, and then the barcode 200 information is read through the barcode reader 50. When the identification information of the RFID tag 200 is read through the RFID reader 40 but the same identification information as the tag identification information read through the RFID reader 40 does not exist in the database 3, the barcode reader 50 may read the barcode information of the reel.

According to an exemplary embodiment, the control unit 80 may identify a reel with a new reel when the database 3 does not contain the same identification information as the tag identification information of the reel read through the RFID reader 40. When the reel is deemed the new reel, the control unit 80 associates the tag identification information of the reel read through the RFID reader 40 with the barcode information read through the barcode reader 50, and stores the associated information in the database 3 through the memory unit 70.

Meanwhile, the reels may have an equal size or different sizes. In order to accurately measure the remaining quantity of the components on the reel, it is needed to know the size of each of the reels. The size of the reel may include not only an outer diameter of the reel but also an inner diameter of the reel on which no tape is wound. Exemplary embodiments to know the size of the reel and measure the remaining quantity of the components of the reel will be described below.

According to an exemplary embodiment, the second sensor 20a detects a size of the reel as well as a diameter of the tape wound on the reel, and the control unit 80 finds out a size of the corresponding reel based on the size information of the reel. In order to detect the size information of the reel, the second sensor 20a may be an image sensor that can take an image. It is possible to know the size of the reel based on the image of the reel taken by the image sensor. The control unit 80 may calculate the remaining quantity of the components received in the reel based on the size information of the reel known through the second sensor 20a, and the diameter size of the tape detected by the second sensor 20a.

According to another exemplary embodiment, to know the size of the reel the control unit 80 may read the size information of the reel from the database 3 using the identification information of the reel. And, the remaining quantity of the components received in the reel may be calculated using the read size information of the reel and the diameter size of the tape detected by the second sensor 20a.

According to further another exemplary embodiment, the control unit 80 may detect the outer diameter of the reel through the second sensor 20a, and read the inner diameter of the reel from the database 3 via the identification information of the reel. Here, the control unit 80 can know the outer and inner diameters of the reel accurately based on the inner diameter of the reel read from the database 3 and the outer diameter of the reel detected by the second sensor 20a, and then calculate the remaining quantity of the components received in the reel using the outer and inner diameters of the reel and the diameter of the tape roll reeled on the reel detected by the second sensor 20a.

The reels having passed through the RFID reader 40 and the barcode reader 50 are transferred to and kept in the storage unit 60. According to the judgement as to whether each of the reels is deemed normal or abnormal by the RFID reader 40 and the barcode reader 50, the reels may be kept in different spaces to be distinguished from each other. The details of the embodiment of the storage unit 60 will be described later with reference to FIG. 7.

FIG. 6c is a block diagram of the reel management system 1c according to the third embodiment of the present disclosure.

With reference to FIG. 6c, the reel management system 1c according to the third embodiment may include a robot arm 10c with the first sensor 100, the movable type second sensor 20b separated from the robot arm 10c, the RFID reader 40, the barcode reader 50, the storage unit 60, the memory unit 70, the control unit 80, and the communication unit 90. The external view of the reel management system 1c according to the third embodiment is the same as that shown in FIG. 4c.

The second sensor 20b according to the third embodiment is separated from the robot arm 10c and detects the diameter size of the tape roll wound on each reel by scanning the entire reels 2 while moving over the entire reels loaded on the reel rest 30. It will now be described for the various embodiments of the movable type second sensor 20b.

According to an exemplary embodiment, the second sensor 20b is a contact-type sensor having an optical sensor to detect the edge of a reel while moving over the entire reels on the reel rest 30. When the edge of the reel is detected by an optical sensor, the contact-type sensor detects contact of the robot arm 10c, which shifts over the detected reel, to the tape wound on the reel and acquires information of the diameter size of the tape in contact with the robot arm 10c.

According to another exemplary embodiment, the second sensor 20b may be an optical displacement sensor that irradiates an optical signal to the entire reels loaded on the reel rest 30 while moving over the entire reels and acquires the information of diameter size of the tape wound on each of the reels from the reflected signal.

According to further another exemplary embodiment, the second sensor 20b may be an image sensor that takes an image of each of the entire reels loaded on the reel rest 30 and acquires the information of diameter size of the tape wound on each of the entire reels using the taken image.

On the other hand, the second sensor 20b may obtain boundary information between the reels, in addition to the diameter size of the tape wound on each reel. For example, when the second sensor 20b is the image sensor, the boundary information between the reels can be obtained from the image of each of the entire reels. The control unit 80 may classify the reels in turn based on the boundary information between the reels obtained through the second sensor 20b, and match the classified reels and the remaining quantity of the components received in each of the reels in sequence.

The robot arm 10c may include the first sensor 100 for detecting any one of the reels 2 loaded on the reel rest 30, and lift the reel detected by the first sensor 100. In this case, the first sensor 100 detects any one among the reels that diameter sizes of the tapes wound on them are obtained by the second sensor 20b, and the control unit 80 lifts up the one reel detected by the first sensor 100 with the robot arm 10c. If the reels 2 are stacked in the vertical direction on the reel rest 30, the reel detected by the first sensor 100 and lifted up by the robot arm 10c may be the reel at the highest position among the reels 2 on the reel rest 30, whereas if the reels 2 are arranged in the horizontal direction on the reel rest, the reel detected by the first sensor 100 and lifted up by the robot arm 10c may be the reel at the leftmost or rightmost position on the reel rest 30.

According to an exemplary embodiment, the first sensor 100 may be an optical sensor that detects the edge of the reel by transmitting and receiving an optical signal to/from the reels 2 loaded on the reel rest 30. The reels 2 are arranged in a line on the reel rest 30. When the edge of a reel is detected by the first sensor 100 firstly, the control unit 80 controls the robot arm 10c to pause and then to move over the detected reel and lift it up with the grippers of the robot arm 10c.

Next, an exemplary embodiment that the robot arm 10c detects any one reel from the reel rest 30 by means of the first sensor 100 and lifts it up will be described.

According to an exemplary embodiment, the first sensor 100 may be an optical sensor. The robot arm 10c driven by the control unit 80 begins its operation in a state that its two grippers are spread wider than a predetermined size of the reel. That is, the robot arm 10c moves toward the reel rest 30 in a state that its two grippers are spaced to be wider than the size of the reel. For example, if the reels 2 are stacked in the vertical direction on the reel rest 30, the robot arm 10c located on the ceiling gradually moves downwardly and detects the edge of the reel via the first sensor 100. During the movement, if the edge of the reel is detected firstly, the robot arm 10c stops its movement. Then, the robot arm 10c shifts over the detected reel and lifts up the reel by gripping it with the two grippers.

According to another exemplary embodiment, the first sensor 100 may include a first optical sensor and a second optical sensor. The robot arm 10c driven by the control unit 80 detects the reel through the first optical sensor while moving toward the reel rest 30. For example, if the reels 2 are stacked in the vertical direction on the reel rest 30, the robot arm 10c located on the ceiling gradually moves downwardly and detects the reel through the first optical sensor. At that time, the robot arm 10c may move at a constant speed with spreading its two grippers. When the reel is detected by the first optical sensor, the robot arm 10c spreads its two grippers wider than the size of the detected reel, and then moves toward the reel rest 30. When the second optical sensor detects the edge of the reel firstly during the movement, the robot arm 10c stops the movement temporarily. Then, the robot arm 10c moves over the detected reel and lifts it up by gripping it with the two grippers.

In the meantime, the control unit 80 drives the robot arm 10c, and calculates the remaining quantity of the reels received in the reel based on the diameter size of the tape roll detected by the second sensor 20b. The control unit 80 may calculate the remaining quantity of the reels based on the area or volume of the tape wound on the reel. For example, the number of the remaining components can be calculated based on the pre-known information such as the entire diameter of the tape roll, the diameter of the blank space of the remaining tape roll, the total number of the components, etc. and the diameter size of the remaining tape roll detected by the second sensor 20b. Here, the above-described methods of calculating the remaining quantity of the components are just exemplary examples, and there may be several different methods of calculating the remaining quantity of the components.

The RFID reader 40 reads the tag identification information via an RFID signal from the RFID tag 200 attached to the reel lifted up by the robot arm 10c to identify the reel, or records the tag identification information in the RFID tag 200. Having read the identification information of the RFID tag 200 of the reel via the RFID reader 40, the control unit 80 retrieves the read identification information from the database 3. If the database 3 contains the same identification information as the read identification information, the remaining quantity of the components calculated by the control unit 80 is recorded in the database 3 to be added to the information of the reel having the identification information.

According to an exemplary embodiment, the RFID reader 40 is installed at a location separated from the robot arm 10c. The robot arm 10c driven by the control unit 80 moves the lifted reel to the vicinity of the RFID reader 40, and the RFID reader 40 reads the identification information from the RFID tag 200 of the reel to identify it. According to another exemplary embodiment, the RFID reader 40 may be mounted on or built in the robot arm 10c. The RFID reader 40 reads the identification information of the reel lifted by the robot arm 10c to identify it.

The memory unit 70 stores the identification information of the reel read from the RFID reader 40 and the information of the remaining quantity of the components of the reel calculated by the control unit 80 in a form of associated information in the database 3. The database 3 may be located in the reel management system 1c. Alternatively, the database 3 may be located in a server separated from the reel management system 1c. In addition, the memory unit 70 may directly record the information of remaining quantity of the components calculated by the control unit 80 in the RFID tag 200 of the reel.

The communication unit 90 transmits the component information, the tag identification information, the barcode information, etc. to the database 3 via the network to be stored. In addition to the transmission of such information, the communication unit 90 may receive the component information from the database 3 via the network. The component information may include the identification information of the components received in the reel and production history data. The identification information relates to the components received in the reel, and may include the component code, the manufacturer name, the production year, the production lot number, etc. The production history data indicates the history of the components from being received in the reel to being used for product production. Further, the component information includes the information of remaining quantity of the components received in the reel.

The bar code reader 50 reads the bar code 210 attached to the reel lifted by the robot arm 10c to identify the reel. The memory unit 70 stores the barcode information read through the bar code reader 50 and the tag identification information of the reel in a form of associated information.

According to an exemplary embodiment, the barcode reader 50 may be located next to the RFID reader 40. In this case, the identification information of the RFID tag 200 of the reel is read by the RFID reader 40, and the barcode 210 information of the reel is read by the barcode reader 50. In a case that the RFID reader 40 succeeds in reading the identification information of the RFID tag but the database 3 does not contain the same information as the identification information read through the RFID reader 40, the barcode reader 50 may read the barcode information of the reel.

According to an exemplary embodiment, if the database 3 does not contain the same identification information as the tag identification information read by the RFID reader 40, the control unit 80 identifies the reel with a new reel. If the reel is identified with the new one, the control unit 80 associates the tag identification information of the reel read through the RFID reader 40 with the barcode information read through the barcode reader 50, and stores the associated information in the database 3 through the memory unit 70.

In the meantime, the sizes of the reels may be equal to each other, or different from each other. In order to correctly measure the remaining quantity of the components received in the reel, it is needed to know the size of each of the reels 2. Here, the size of the reel may include not only an outer diameter of the reel but also an inner diameter of the reel that is not reeled with the tape. Described below is an exemplary embodiment to detect the size of the reel and measure the remaining quantity of the components of the reel.

According to an exemplary embodiment, the second sensor 20b detects a diameter size of the tape roll wound on the reel as well as the size information of the reel, and the control unit 80 calculates the size of the reel using the size information of the reel. In order to detect the size information of the reel, the second sensor 20b may be an image sensor that can acquire an image of the reel. It is possible to find out the size of the reel based on the image of the reel obtained through the image sensor. The control unit 80 calculates the remaining quantity of the components received in the reel based on the size of the reel detected by the second sensor 20b and the diameter size of the tape roll wound on the reel that is detected by the second sensor 20b.

According to another exemplary embodiment, the control unit 80 finds out the size of the reel by reading the size information of the reel from the database 3 using the identification information of the reel. Further, the control unit 80 calculates the remaining quantity of the components received in the reel using the read size information of the reel and the diameter size of the tape detected by the second sensor 20b.

According to further another exemplary embodiment, the control unit 80 comes to know the outer diameter of the reel through the second sensor 20b, and reads the inner diameter of the reel from the database 3 using the identification information of the reel. Here, the control unit 80 can accurately determine sizes of the outer and inner diameter sizes of the reel based on the inner diameter size of the reel read from the database 3 and the outer diameter of the reel detected by the second sensor 20b, and then calculate the remaining quantity of the components received in the reel using the outer and inner diameter sizes of the reel and the diameter size of the tape roll detected by the second sensor 20b.

In the storage unit 60, the reels having passed through the RFID reader 40 and the barcode reader 50 are housed. In detail, the reels may be distinguishably kept in different spaces relying on whether each of the reels is identified with a normal one or an abnormal one by the RFID reader and the barcode reader 50. Detailed description of the exemplary embodiment of the storage unit 60 will be given later with reference to FIG. 7.

FIG. 6d is a block diagram of the reel management system 1d according to the fourth embodiment of the present disclosure.

Referring to FIG. 6d, the reel management system 1d according to the fourth embodiment includes a robot arm 10d having the first sensor 100 and a second sensor 20c, the RFID reader 40, the barcode reader 50, the storage unit 60, the memory unit 70, the control unit 80, and the communication unit 90. The external view of the reel management system 1d according to the fourth embodiment is the same as that described in FIG. 4d.

The second sensors 20a and 20b are located outside of the robot arms 10b and 10c, respectively, as above-described with reference to FIGS. 6b and 6c. In contrast, according to the fourth embodiment shown in FIG. 6d the second sensor 20c is mounted on or built in the robot arm 10d. The robot arm 10d detects any one reel among the reels loaded on the reel rest 30 through the first sensor 100, and obtains the diameter size of the tape wound on the reel through the second sensor 20c during the operation of lifting the detected one reel. Detecting the reel by the first sensor 100 and obtaining the diameter size of the tape may be performed at the same time.

In detail, the first sensor 100 embedded in the robot arm 10d detects any one reel among the reels 2 loaded on the reel rest 30. If the reels 2 are stacked in the vertical direction on the reel rest 30, the reel at the highest position among the reels 2 on the reel rest 30 may be detected by the first sensor 100 and lifted up by the robot arm 10d. If the reels 2 are arranged in the horizontal direction on the reel rest 30, the reel at the leftmost or rightmost position among the reels 2 on the reel rest 30 may be detected by the first sensor 100 and lifted up by the robot arm 10d.

The second sensor 20c included in the robot arm 10d is to detect the diameter size of the tape wound on the reel detected by the first sensor 100. For this purpose, the second sensor 20c may be a contact-type sensor that detects the contact of the robot arm 10d to the tape wound on any one reel detected by the first sensor 100 and obtains the diameter size of the tape in contact with the robot arm 10d.

In the meantime, the control unit 80 drives the robot arm 10d, and calculates the remaining quantity of the reels 2 received in the reel based on the diameter size of the tape detected by the second sensor 20c. Alternatively, the control unit 80 may calculate the remaining quantity of the components based on the area or volume of the tape wound on the reel. For example, the number of the remaining components can be calculated based on the pre-known information such as the entire diameter of the tape roll, the diameter of the blank space of the tape roll, the total number of the components, etc. and the diameter size of the remaining tape roll detected by the second sensor 20c. Here, the above-described methods of calculating the remaining quantity of the components are just exemplary examples, and there may be several other methods of calculating the remaining quantity of the components.

The RFID reader 40 reads the tag identification information from via the RFID signal from the RFID tag 200 attached to the reel lifted up by the robot arm 10d to identify the reel, or records the tag identification information in the RFID tag 200. Having read the identification information of the RFID tag 200 of the reel via the RFID reader 40, the control unit 80 retrieves the same identification information as the read identification information from the database 3. If the database 3 contains the same identification information as the read identification information, the remaining quantity information of the components calculated by the control unit 80 is recorded additively to the information of the reel having the identification information.

According to an exemplary embodiment, the RFID reader 40 is installed at a location separated from the robot arm 10d. The robot arm 10d driven by the control unit 80 moves the lifted reel to the vicinity of the RFID reader 40, and the RFID reader 40 reads the identification information from the RFID tag 200 of the reel to identify it. According to another exemplary embodiment, the RFID reader 40 may be mounted on or built in the robot arm 10d. The RFID reader reads the identification information of the reel lifted by the robot arm 10d to identify it.

The memory unit 70 stores the identification information of the reel read through the RFID reader 40 and the information of the remaining quantity of the components of the reel calculated by the control unit 80 in a form of associated information in the database 3. The database 3 may be located in the reel management system 1d. Alternatively, the database 3 may be located in a server separated from the reel management system 1d. In addition, the memory unit 70 may directly record the information of remaining quantity of the components calculated by the control unit 80 in the RFID tag 200 of the reel.

The communication unit 90 transmits the component information, the tag identification information, the barcode information, etc. to the database 3 via the network to be stored in the database 3. In addition to the transmission of such information, the communication unit 90 may receive the component information from the database 3 via the network. The component information may include the identification information of the components received in the reel and production history data. The identification information relates to the components received in the reel, and may include the component code, the manufacturer name, the production year, the production lot number, etc. The production history data indicates the history of the component from being received in the reel to being used for the production. Further, the component information may include the information of remaining quantity of the components received in the reel.

The barcode reader 50 reads the barcode 210 attached to the reel lifted by the robot arm 10d to identify the lifted reel. The memory unit 70 stores the barcode information read through the bar code reader 50 and the tag identification information of the reel in a form of associated information.

According to an exemplary embodiment, the barcode reader 50 may be located next to the RFID reader 40. In this case, the identification information of the RFID tag 200 of the reel is read by the RFID reader 40, and the barcode 210 information of the reel is read by the barcode reader 50. In a case that the RFID reader 40 succeeds in reading the identification information of the RFID tag but the database 3 does not contain the same information as the identification information read through the RFID reader 40, the barcode reader 50 may read the barcode information of the reel.

According to an exemplary embodiment, if the database 3 does not contain the same identification information as the tag identification information read by the RFID reader 40, the control unit 80 identifies the reel with a new reel. If the reel is identified with the new one, the control unit 80 associates the tag identification information of the reel read through the RFID reader 40 with the barcode information read through the barcode reader 50, and stores the associated information in the database 3 through the memory unit 70.

In the meantime, the sizes of the reels may be equal to each other, or different from each other. In order to correctly measure the remaining quantity of the components received in the reel, it is needed to know the size of each of the reels. Here, the size of the reel may include not only an outer diameter of the reel but also an inner diameter of the reel that is not wound with the tape. Described below is an exemplary embodiment to detect the size information of the reel and measure the remaining quantity of the components of the reel.

According to an exemplary embodiment, the second sensor 20c detects a diameter size of the tape wound on the reel as well as the size information of the reel, and the control unit 80 calculates the size of the reel using the size information of the reels. In order to detect the size information of the reel, the second sensor 20c may be an image sensor that can acquire image information of the reel. It is possible to find out the size of the reel based on the image of the reel obtained through the image sensor. The control unit 80 calculates the remaining quantity of the components received in the reel based on the size information of the reel detected by the second sensor 20c and the information of the diameter size of the tape wound on the reel that is detected by the second sensor 20c.

According to another exemplary embodiment, the control unit 80 determines the size of the reel by reading the size information of the reel from the database 3 using the identification information of the reel. Further, the control unit 80 calculates the remaining quantity of the components received in the reel using the read size information of the reel and the information of the diameter size of the tape detected by the second sensor 20c.

According to further another exemplary embodiment, the control unit 80 detects an outer diameter of the reel through the second sensor 20c, and reads an inner diameter of the reel from the database 3 using the identification information of the reel. Here, the control unit 80 accurately determines the outer and inner diameter sizes of the reel based on the inner diameter size of the reel read from the database 3 and the outer diameter of the reel detected by the second sensor 20c, and then calculates the remaining quantity of the components received in the reel using the outer and inner diameters of the reel and the diameter size of the tape detected by the second sensor 20c.

In the storage unit 60, the reels having passed through the RFID reader 40 and the barcode reader 50 are housed. In detail, the reels may be distinguishably kept in different spaces relying on whether each of the reels is identified with a normal one or an abnormal one through the RFID reader 40 and the barcode reader 50. Detailed description of the exemplary embodiment of the storage unit 60 will be given below with reference to FIG. 7.

FIG. 7 illustrates an external view of the storage unit 60 according to an exemplary embodiment of the present disclosure.

With reference to FIG. 7, the storage unit 60 includes a first storage unit 610 and a second storage unit 620.

According to an exemplary embodiment, the reels may be classified by the robot arm into either a normal one or an abnormal one based on the recognition result by at least one of the RFID reader 40 and the barcode reader 50, and the normal reel and the abnormal reel may be kept so as to be distinguished from each other.

In detail, the reels deemed the normal one based on the recognition result by at least one of the RFID reader 40 and the barcode reader 50 are kept in the first storage unit 610 after being moved by the robot arm. The cases that the reel is identified with the normal one are as follows: a case that reading the identification information of the RFID tag through the RFID reader succeeds and the database contains identification information that is equal to the identification information read through the RFID reader 40, a case that reading the identification information of the RFID tag 200 through the RFID reader 40 succeeds, and the database does not contain any identification information that is equal to the identification information read through the RFID reader 40 but reading the barcode information through the barcode reader 50 succeeds, etc.

The reels deemed the abnormal one based on the recognition result by at least one of the RFID reader 40 and the barcode reader 50 are kept in the second storage unit 620 after being moved by the robot arm. The cases that the reel is identified with the abnormal one are as follows: a case that reading the identification information of the RFID tag 200 through the RFID reader 40 does not succeed, a case that reading the identification information of the RFID tag 200 through the RFID reader 40 succeeds but the database is not registered with the read tag identification information, and although the barcode reader 50 tries to read the barcode information but fails, etc.

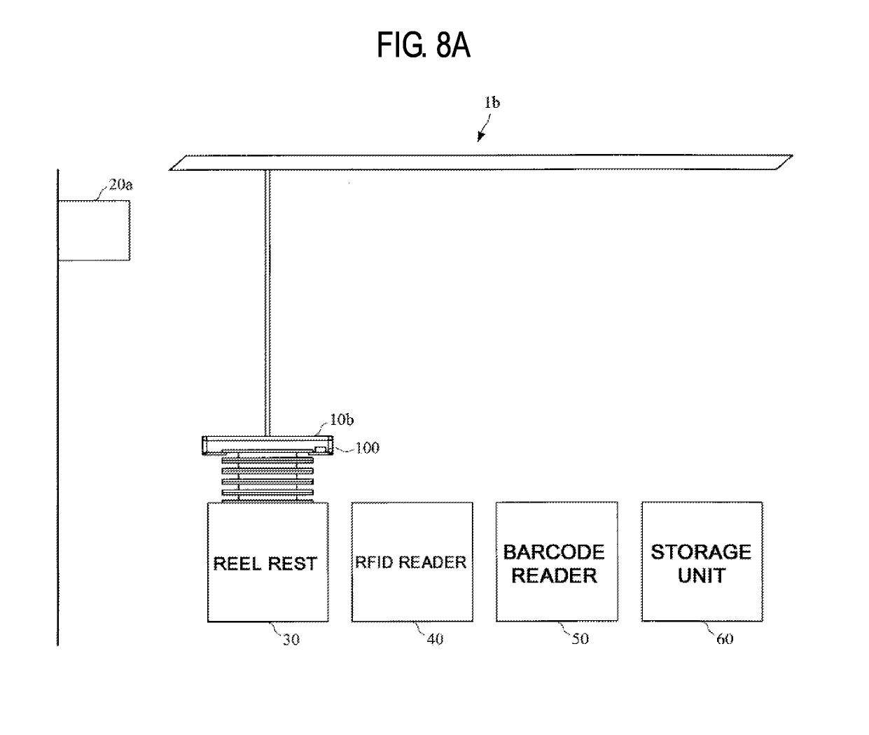

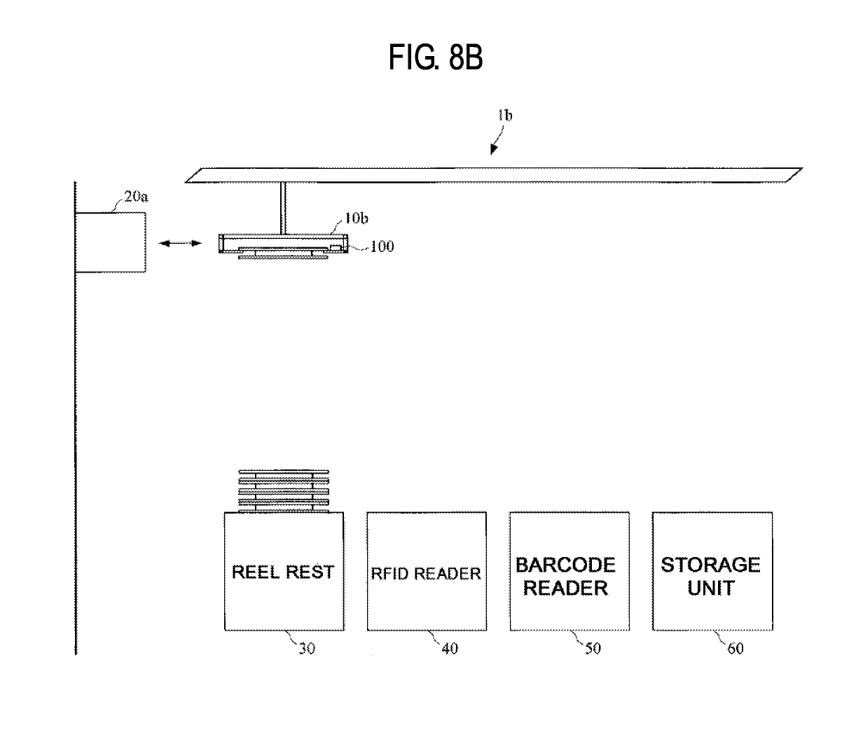

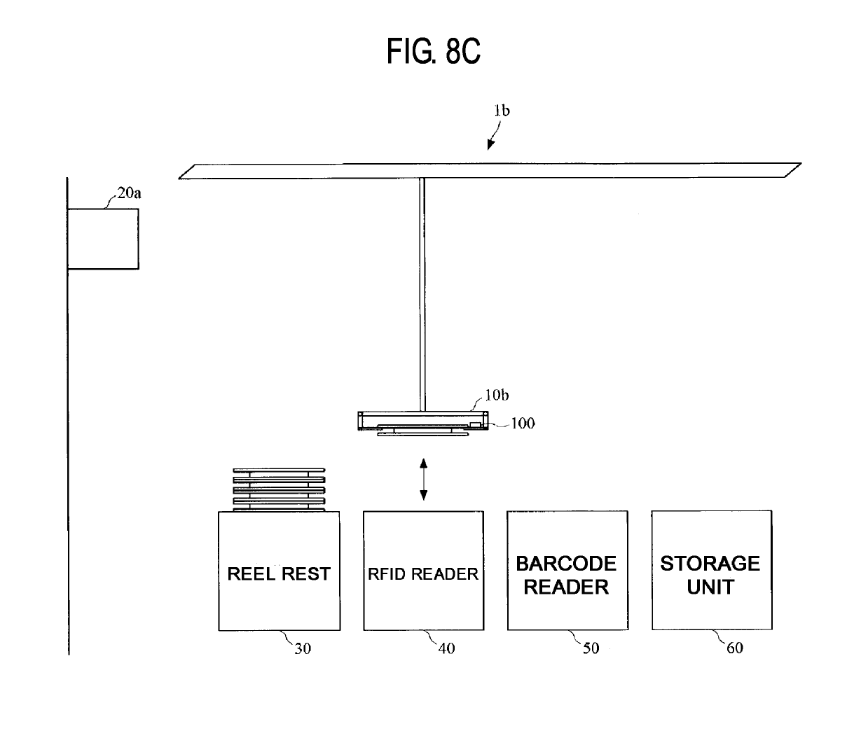

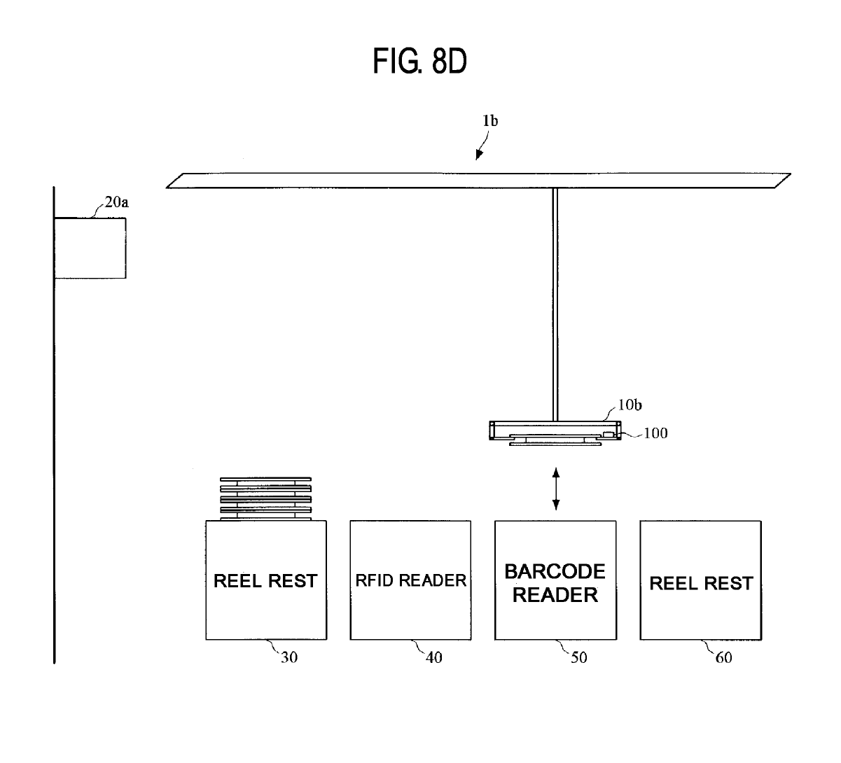

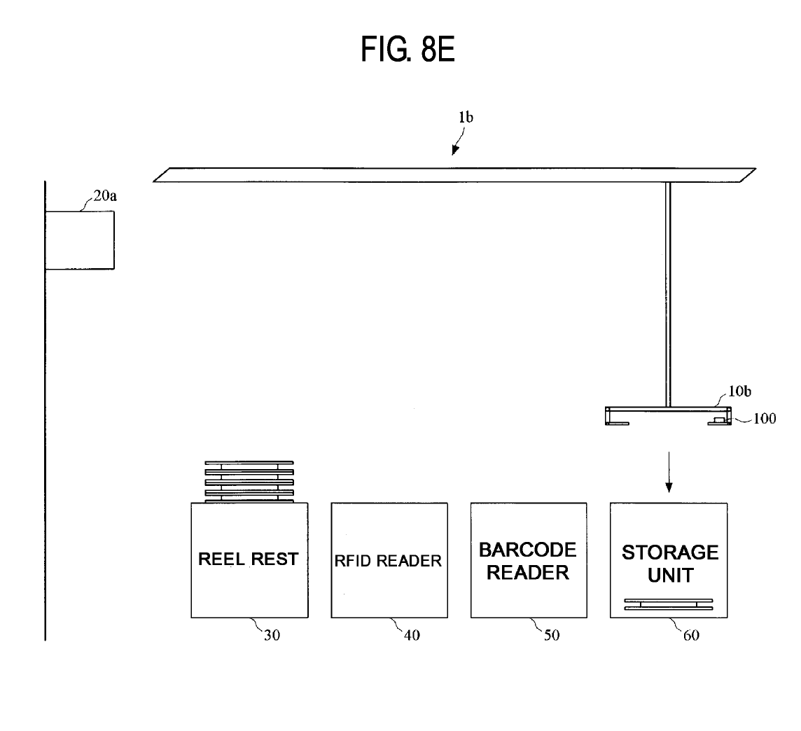

FIGS. 8a to 8e are referential diagrams to describe the operation process of the reel management system 1b according to the second embodiment of the present disclosure.

As shown in FIG. 8a, the robot arm 10b detects any one of the reels 2 loaded on the reel rest 30 by means of the first sensor 100 included in the robot arm 10b. Then, the robot arm 10b lifts up the reel detected by the first sensor 100 to the height of the second sensor 20a that is separated from the robot arm 10b and located at a fixed position.

As shown in FIG. 8b, the fixed type second sensor 20a acquires the information of diameter size of the tape reeled on the reel lifted up by the robot arm 10b. Then, the remaining quantity of the components received in the reel can be calculated by a processor based on the diameter size of the tape detected by the second sensor 20a, and then the robot arm 10b moves the reel of which remaining quantity of the components is calculated to the vicinity of the RFID reader 40.

As shown in FIG. 8c, the RFID reader 40 reads the tag identification information from via an RFID signal from the RFID tag 200 attached to the reel moved by the robot arm 10b to identify the reel, or records the tag identification information in the RFID tag 200. If the same information as the tag identification information of the reel read through the RFID reader 40 exists in the database 3, the information of the reel having the identification information is associated with the identification of the reel and the calculated remaining quantity of the components. And, the associated information is recorded in the database 3. Then, the robot arm 10b moves the reel of which tag identification information has been read through the RFID reader 40 to the vicinity of the barcode reader 50.

As shown in FIG. 8d, the barcode reader 50 reads the barcode attached to the reel moved by the robot arm 10b to identify the reel. The barcode information read through the barcode reader 50 is associated with the tag identification information of the reel and the associated information is recorded in the database 3. Then, as shown in FIG. 8e, the reels having passed through the RFID reader 40 and the barcode reader 50 are stored in the storage unit 60.

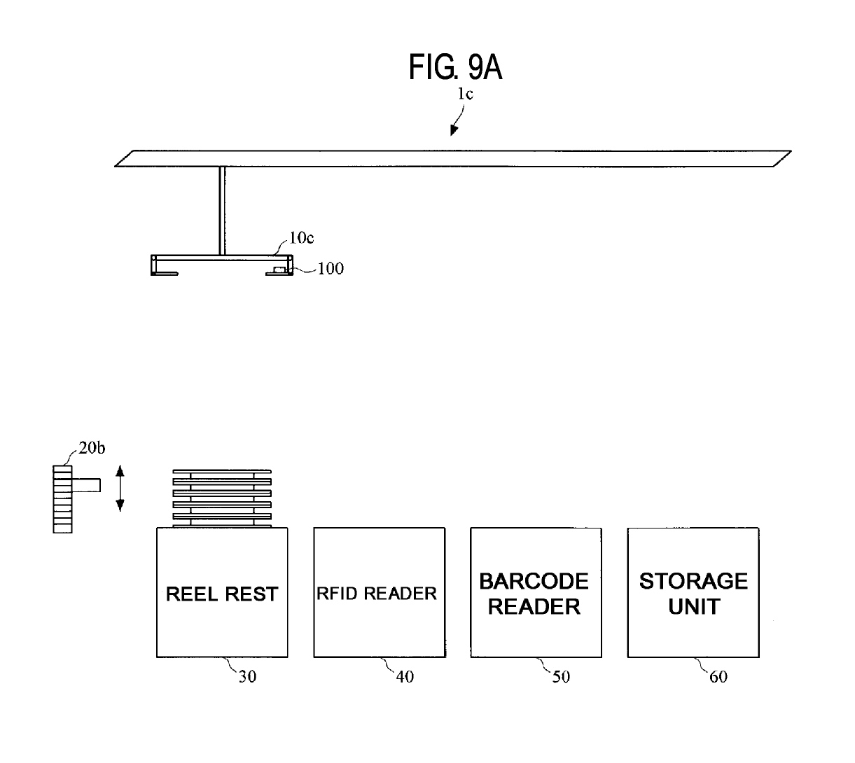

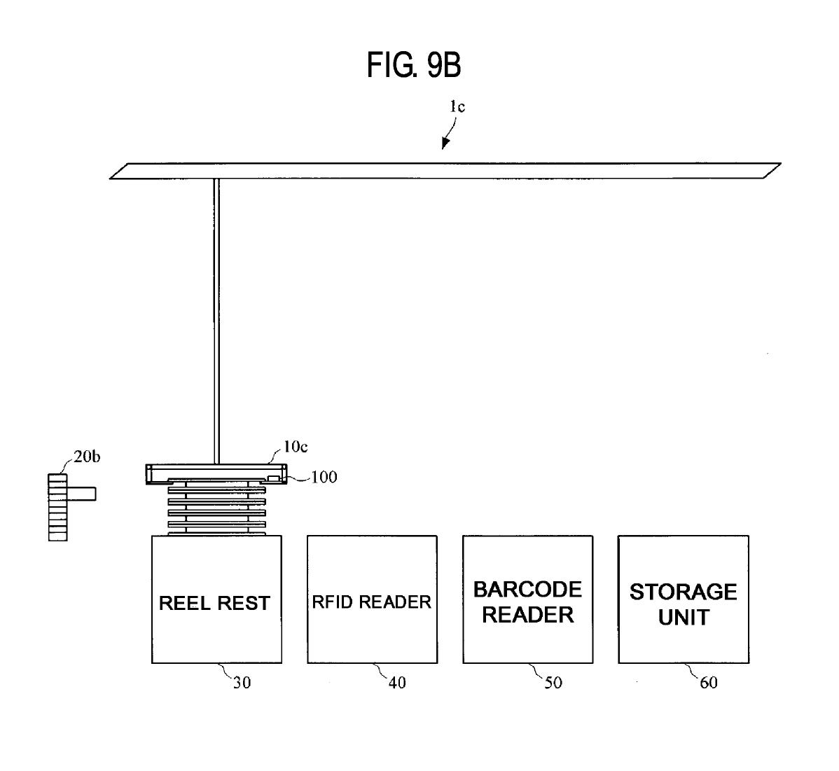

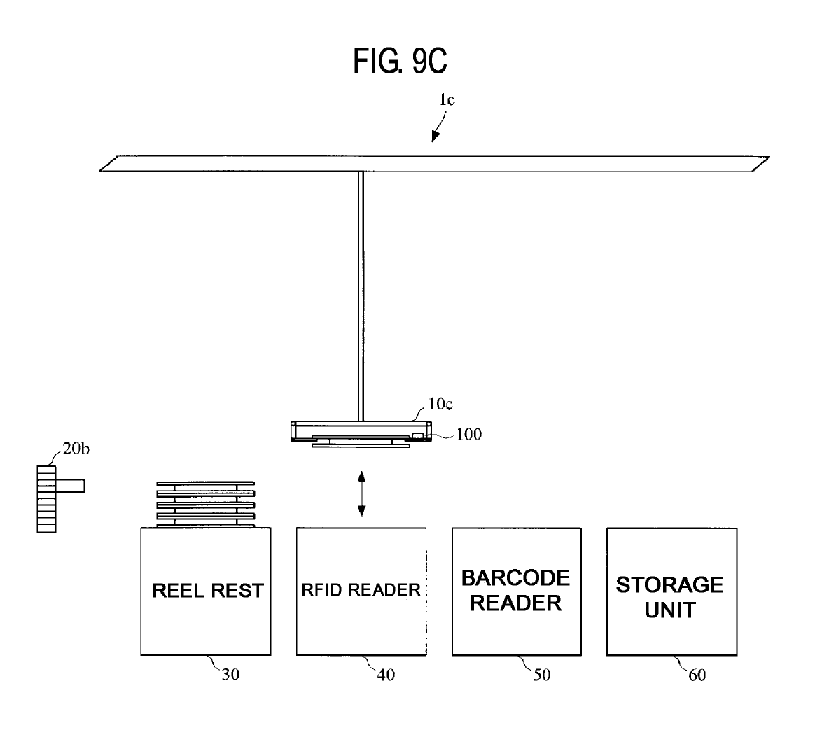

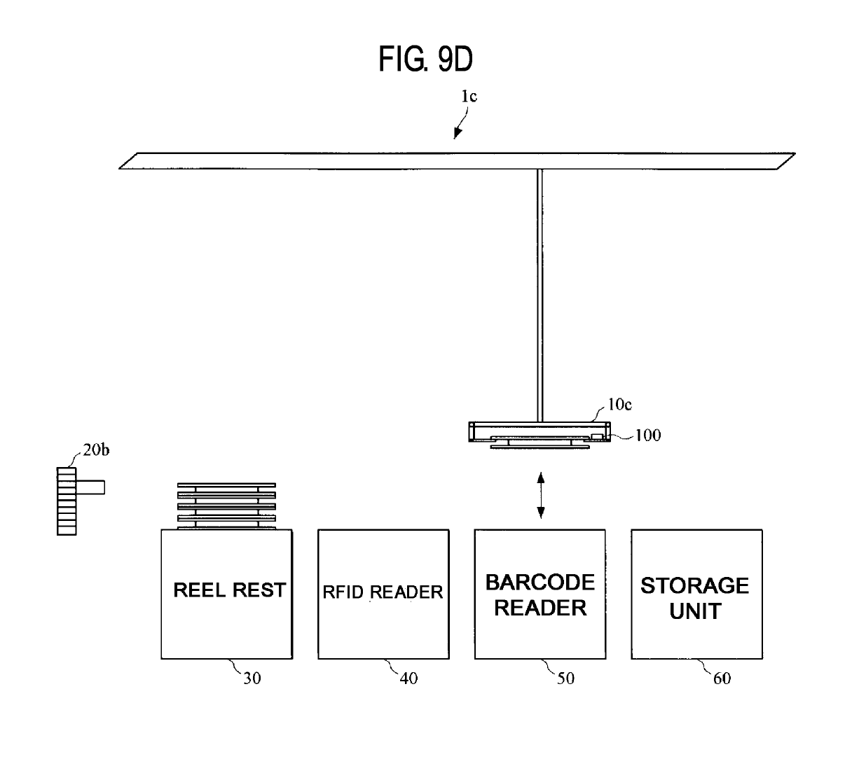

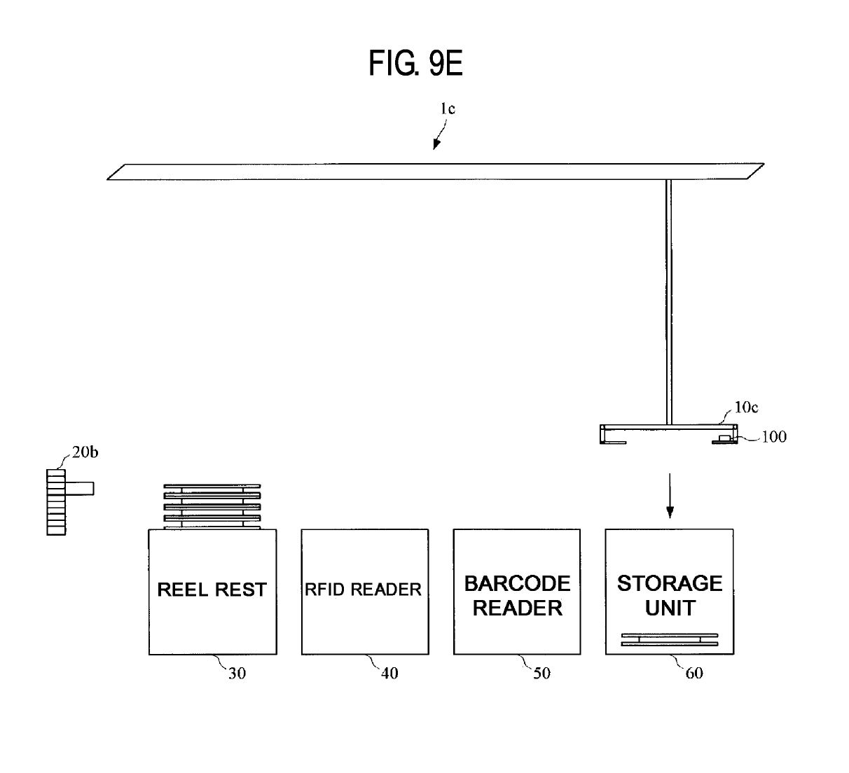

FIGS. 9a to 9e illustrate the operation process of the reel management system 1c according to the third embodiment of the present disclosure.

As shown in FIG. 9a, the second sensor 20b according to the third embodiment is separate from the robot arm 10c, and detects the diameter size of the tape roll wound on each of the entire reels 2 loaded on the reel rest 30 while moving over the reels 2 to scan them.

Once having detected the diameter sizes of the tape rolls wound on all the reels 2, the robot arm 10c detects any one reel among the entire reels 2 loaded on the reel rest 30 through the first sensor 100 installed in the robot arm 10c as shown in FIG. 9b. Then, the robot arm 10c lifts up the reel detected by the first sensor 100. The remaining quantity of the components received in the reel is calculated by a processor based on the diameter size of the tape roll detected by the second sensor 20b, and then the robot arm 10c shifts the reel for which the calculation of the remaining quantity of the components is completed to the vicinity of the RFID reader 40.

As shown in FIG. 9c, the RFID reader 40 reads the tag identification information via the RFID signal from the RFID tag 200 attached to the reel moved by the robot arm 10c to identify the reel, or records the tag identification information in the RFID tag 200. If the same information as the tag identification information of the reel read through the RFID reader 40 exists in the database 3, the information of the reel having the identification information is associated with the identification of the reel and the calculated remaining quantity of the components and the associated information is recorded in the database 3. Then, the robot arm 10c moves the reel of which tag identification information has been read through the RFID reader 40 to the vicinity of the barcode reader 50.

As shown in FIG. 9d, the bar code reader 50 reads the barcode attached to the reel moved by the robot arm 10c. The barcode information read by the barcode reader 50 is associated with the tag identification information of the reel and the associated information is stored in the database 3. Then, the reels having passed through the RFID reader 40 and the barcode reader 50 are stored in the storage unit 60 as shown in FIG. 9e.

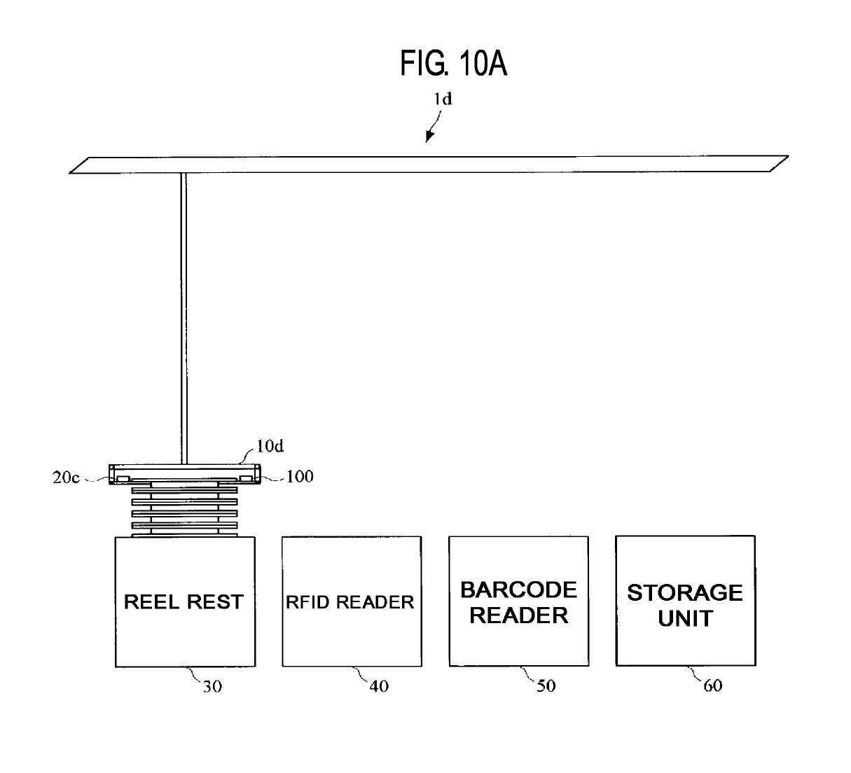

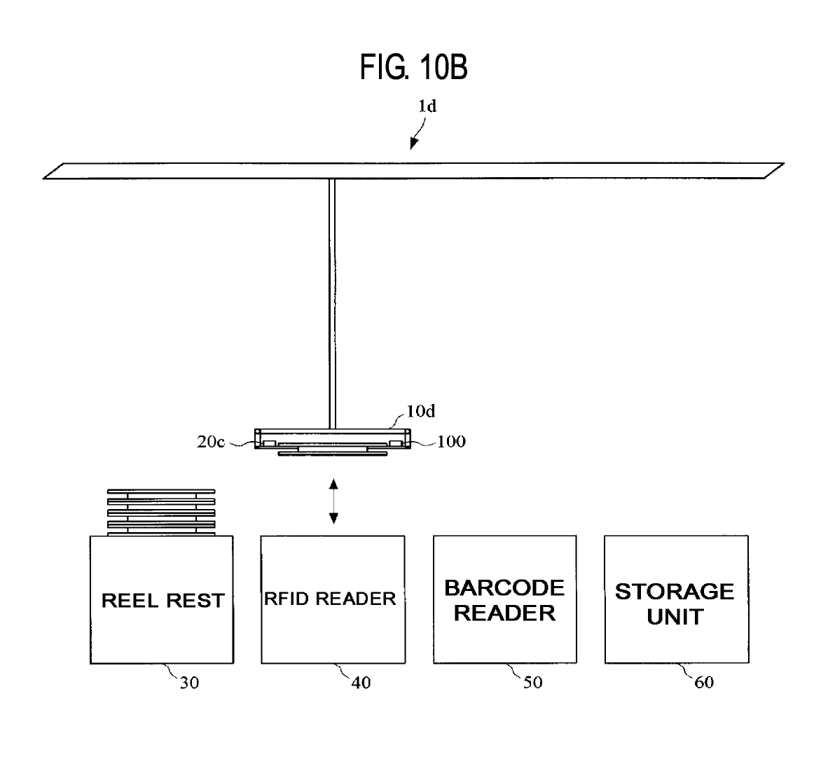

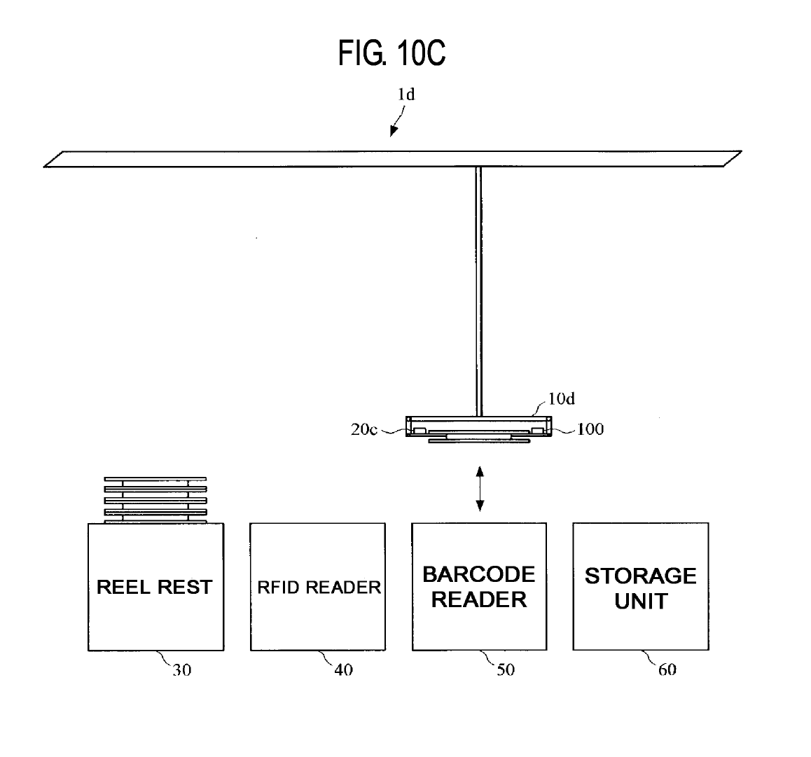

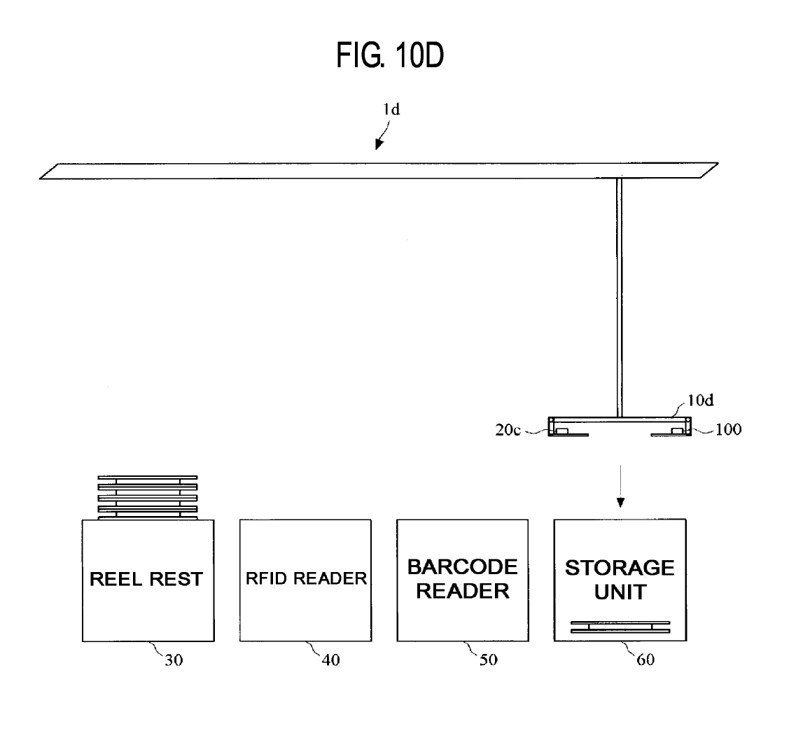

FIGS. 10a to 10d illustrate the operation process of the reel management system 1d according to a fourth embodiment of the present disclosure.

The robot arm 10d according to the fourth embodiment includes the first sensor 100 and a second sensor 20c. As shown in FIG. 10a, the robot arm 10d detects any one reel out of the reels 2 loaded on the reel rest 30 through the first sensor 100 installed in the robot arm 10d, and obtains the diameter size of the tape roll wound on the detected reel through the second sensor 20c installed in the robot arm 10d during the operation of lifting the detected reel. The reel detection by the first sensor 100 and the diameter size detection of the tape roll by the second sensor 20c may be performed at the same time. The remaining quantity of the components received in the reel is calculated by a processor based on the diameter size of the tape roll detected by the second sensor 20c, and then the robot arm 10d shifts the reel for which the calculation of the remaining quantity of the components is completed to the vicinity of the RFID reader 40.

As shown in FIG. 10b, the RFID reader 40 reads the tag identification information via the RFID signal from the RFID tag 200 attached to the reel moved by the robot arm 10d to identify the reel, or records the tag identification information in the RFID tag 200. If the same information as the tag identification information of the reel read through the RFID reader 40 exists in the database 3, the information of the reel having the identification information is associated with the identification of the reel and the calculated remaining quantity of the components, and then the associated information is recorded in the database 3. Then, the robot arm 10d moves the reel of which tag identification information has been read through the RFID reader 40 to the vicinity of the barcode reader 50.

As shown in FIG. 10c, the bar code reader 50 reads the barcode attached to the reel moved by the robot arm 10d. The barcode information read by the barcode reader 50 is associated with the tag identification information of the reel and then the associated information is stored in the database 3. Then, the reels having passed through the RFID reader 40 and the barcode reader 50 are stored in the storage unit 60 as shown in FIG. 10d.

The foregoing is illustrative of exemplary embodiments of the present inventive concept and is not to be construed as limiting thereof. Although a few exemplary embodiments have been described, those skilled in the art will readily appreciate that many modifications are possible in the exemplary embodiments without materially departing from the novel teachings and advantages of the present inventive concepts. Accordingly, all such modifications are intended to be included within the scope of the present inventive concepts as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A reel management system, comprising:
a robot arm, including a first sensor for sensing a predetermined reel out of at least one reel loaded on a reel rest, for holding and moving the reel detected by the first sensor;
an RFID reader for reading tag identification information to identify the reel using an RFID signal from an RFID tag attached to the reel moved by the robot arm;
a barcode reader for reading barcode information assigned to the reel moved by the robot arm;
a memory unit for storing reel-relevant information; and
a control unit for driving the robot arm, determining a state of the reel, and when the reel is identified with a new reel, associating the tag identification information of the reel read by the RFID reader with the barcode information read by the barcode reader, and storing the associated information in a database through the memory unit to register the reel.

2. The reel management system of claim 1, wherein the control unit retrieves the same identification information as the identification information of the reel read by the RFID reader from the database, and identifies the reel with a new reel when the same identification information does not exist in the database.

3. The reel management system of claim 1, wherein the control unit retrieves basic information corresponding to the barcode information read through the barcode reader from the database, associating the retrieved basic information with the tag identification information read through the RFID reader, associating the tag identification information associated with the basic information with the barcode information read through the barcode reader, and storing the associated information in the database to register the new reel.

4. The reel management system of claim 3, wherein after the basic information and the tag identification information are associated with each other, the control unit can read the tag identification information through the RFID reader together with the basic information when reading the tag identification information through the RFID reader.

5. The reel management system of claim 1, wherein the control unit determines whether the reel is normal or not based on recognition result through at least one of the RFID reader and the barcode reader.

6. The reel management system of claim 5, wherein the control unit identifies the reel with a normal reel when reading the identification information of the RFID tag through the RFID reader succeeds and the database contains the same identification information as the identification information of the RFID tag read through the RFID reader, or when reading the identification information of the RFID tag through the RFID reader succeeds and the database does not contain the same identification information as the identification information of the RFID tag read through the RFID reader, but reading the barcode information through the barcode reader succeeds.

7. The reel management system of claim 5, wherein the control unit identifies the reel with an abnormal reel when reading the identification information of the RFID tag through the RFID reader does not succeed, or when reading the identification information of the RFID tag through the RFID reader succeeds but reading the barcode information through the barcode reader does not succeed.

8. The reel management system of claim 5, wherein the reel management system further comprises a first storage unit for storing the reel, which is moved to the first storage unit by the robot arm, identified with the normal one by the control unit based on the recognition result through at least one of the RFID reader and the barcode reader, and a second storage unit for storing the reel, which is moved to the second storage unit by the robot arm, identified with the abnormal one by the control unit based on the recognition result through at least one of the RFID reader and the barcode reader.

9. A reel management system, comprising:
a robot arm, including a first sensor for sensing a predetermined reel out of at least one reel loaded on a reel rest, for holding and moving the reel detected by the first sensor;
a second sensor for detecting a diameter size of a tape wound on a reel held by the robot arm or wound on each of the entire reels loaded on the reel rest prior to being held by the robot arm;
a control unit for driving the robot arm, and calculating remaining quantity of components received in a desired reel based on the diameter size of the tape wound on the desired reel;
an RFID reader for reading tag identification information to identify the reel using an RFID signal from an RFID tag attached to the reel moved by the robot arm; and
a memory unit for storing identification information of the reel read through the RFID reader and remaining quantity of the components loaded on the desired reel calculated by the control unit, in a form of associated information.

10. The reel management system of claim 9, wherein the first sensor is an optical sensor for detecting edge of each of the at least one reel loaded on the reel rest through transmission and receipt of an optical signal, and the control unit controls the robot arm to pause when the first sensor detects the edge of the reel firstly, and then controls the robot arm so as to move over the detected reel and transfer the detected reel with holding the detected reel.

11. The reel management system of claim 10, wherein the first sensor includes an optical sensor, and the control unit detects the edge of the reel through the optical sensor while controlling the robot arm to shift toward the reel rest in a state that two grippers of the robot arm are spread out wider than a predetermined size of the reel, and controls the robot arm to pause, then move over the detected reel, and hold the reel with two grippers of the robot arm when the edge of the reel is detected firstly.

12. The reel management system of claim 10, wherein the first sensor includes a first optical sensor and a second optical sensor, and the control unit, when the first sensor detects the reel during shifting the robot arm toward the reel rest, detects edge of the reel through the second optical sensor while shifting the robot arm toward the reel rest in a state that two grippers of the robot arm are spread wider than a size of the detected reel, and controls the robot arm to pause, then move over the detected reel, and hold the reel with the two grippers of the robot arm when the edge of the reel is detected firstly.

13. The reel management system of claim 9, wherein the second sensor, being separate from the robot arm and fixed to a position of a predetermined height, detects a diameter size of a tape wound on a reel shifted to the height of the second sensor by the robot arm under control by the control unit.

14. The reel management system of claim 13, wherein the second sensor is an optical displacement sensor for irradiating an optical signal to the reel shifted to the height of the second sensor, and detecting a diameter size of the tape wound on the reel using a reflected signal.

15. The reel management system of claim 13, wherein the second sensor is an image sensor for taking an image of the reel shifted to the height of the second sensor and detecting a diameter size of the tape wound on the reel using the taken image.

16. The reel management system of claim 9, wherein the second sensor, being separate from the robot arm, scans the entire reels loaded on the reel rest while moving along in a reel-loading-direction of the entire reels and detects a diameter size of the tape wound on each of the entire reels, and the first sensor detects a predetermined reel out of the reels of which diameter sizes of the tapes wound on them are detected by the second sensor, and the control unit shifts the reel detected by the first sensor with holding the reel by the robot arm.

17. The reel management system of claim 16, wherein the second sensor is a contact-type sensor including an optical sensor for detecting edge of the reel while moving over the entire reels loaded on the reel rest, and the contact-type sensor detects contact of the robot arm, which moves over the detected reel under control by the control unit, to the tape wound on the reel and detects a diameter size of the tape in contact when the optical sensor detects the edge of the reel.

18. The reel management system of claim 16, wherein the second sensor is an optical displacement sensor for irradiating an optical sensor while shifting over the entire reels loaded on the reel rest, and detects a diameter size of the tape wound on each of the reels via a reflected signal therefrom.

19. The reel management system of claim 16, wherein the second sensor is an image sensor for taking an image of each of the entire reels loaded on the reel rest and detecting a diameter size of the tape wound on each of the entire reels using the taken image.

20. The reel management system of claim 16, wherein the second sensor detects a diameter size of the tape wound on each of the reels as well as inter-reel boundary information, and the control unit classifies the reels in order based on the inter-reel boundary information detected by the second sensor and matches the classified reels to the remaining quantity of the components received in each of the reels in order.

21. The reel management system of claim 9, wherein the second sensor is a contact-type sensor, being included in the robot arm, for detecting contact of the robot arm to the tape wound on the reel detected by the first sensor and detecting a diameter size of the tape in contact.

22. The reel management system of claim 9, wherein the reel management system further comprises a reel support for supporting at least one reel loaded on the reel rest to be arranged in a line along a reel-loading direction.

23. The reel management system of claim 22, wherein the reel support includes a rod to be inserted into a hole formed at the center of each of the reels.

24. The reel management system of claim 22, wherein the control unit retrieves identification information of the RFID tag of the reel read by the RFID reader from a database when the RFID reader reads the identification information of the RFID tag of the reel, and the memory unit records in the database the remaining quantity information of the components calculated by the control unit in addition to the information of a reel of which identification information is the same as the read identification information when the database contains the same identification information as the read identification information.

25. The reel management system of claim 9, wherein the RFID reader is installed at a position separated from the robot arm, and the control unit controls the robot arm to hold and shift the reel to the RFID reader so that the RFID reader can read the identification information of the reel for identification.

26. The reel management system of claim 9, wherein the RFID reader, being mounted on or built in the robot arm, reads the identification information of the reel held by the robot arm for identification.

27. The reel management system of claim 9, wherein the reel management system further comprises a barcode reader for reading a barcode attached to the reel shifted by the robot arm, and the control unit associates the barcode information read through the barcode reader with the tag identification information of the reel and stores the associated information.

28. The reel management system of claim 27, wherein when tag identification information of a reel is read by the RFID reader, the control unit retrieves corresponding identification information to tag identification information of the reel read through the RFID reader from a database, identifying the reel with a new reel when the corresponding identification information is not searched, associating the tag identification information of the reel read through the RFID reader with barcode information read through the barcode reader, and storing the associated information in the database through the memory unit.

29. The reel management system of claim 27, wherein the reel management system further comprises a first storage unit for storing the reel, which is shifted to the first storage unit by the robot arm, identified with the normal one by the control unit based on the recognition result through at least one of the RFID reader and the barcode reader after calculation of remaining quantity of the components.

30. The reel management system of claim 29, wherein the control identifies a reel with a normal reel and controls the robot arm to move the reel to be stored in the first storage unit, when reading the identification information of the RFID tag through the RFID reader succeeds and the database contains the same identification information as the identification information of the RFID tag read through the RFID reader, or when reading the identification information of the RFID tag through the RFID reader succeeds and the database does not contain the same identification information as the identification information of the RFID tag read through the RFID reader, but reading the barcode information through the barcode reader succeeds.

31. The reel management system of claim 29, wherein the reel management system further comprises a second storage unit for storing a reel, which is moved to the second storage unit by the robot arm, identified with the abnormal one by the control unit based on the recognition result through at least one of the RFID reader and the barcode reader after calculation of remaining quantity of the components.

32. The reel management system of claim 31, wherein the control unit identifies a reel with an abnormal one when reading the identification information of the RFID tag through the RFID reader does not succeed, or when reading the identification information of the RFID tag through the RFID reader succeeds but reading the barcode information through the barcode reader does not succeed, and controls the robot arm to transfer the reel to be stored in the second storage unit.

33. The reel management system of claim 9, wherein the second sensor detects a diameter size of a tape wound on the reel and size information of the reel, and the control unit determines a size of the reel based on the size information of the reel and calculates remaining quantity of components received in the reel based on the size information of the reel and the diameter size of the tape detected by the second sensor.

34. The reel management system of claim 9, wherein the control unit finds out a size of the reel by reading size information of the reel from a database using identification information of the reel, and calculates remaining quantity of components received in the reel based on the read size information of the reel and the diameter size of a tape wound on the reel detected by the second sensor.

35. The reel management system of claim 34, wherein the control unit finds out an outer diameter of the reel through detection by the second sensor, reading an inner diameter of the reel from the database using identification information of the reel, determining the outer diameter and the inner diameter of the reel, and then calculating the remaining quantity of the components received in the reel using the outer and inner diameters of the reel and the diameter size of the tape wound on the reel detected by the second sensor.

36. The reel management system of claim 9, wherein the memory unit records information of remaining quantity of the components calculated by the control unit in a RFID tag of the corresponding reel.

37. The reel management system of claim 9, wherein the reel management system further comprises a communication unit for transmitting and receiving data to and from an external server, and transmitting the remaining quantity of the components calculated by the control unit so as to be stored in the server.

38. The reel management system of claim 9, wherein the robot arm moves to the reel rest and lifts up a predetermined reel among at least one reel on the reel rest.

39. The reel management system of claim 9, wherein the robot arm holds a reel detected by the first sensor among the reels shifted to the robot arm by the reel rest.
